(19) United States
(12) Patent Application Publication
(10) Pub. No.: US 2026/0194913 A1
(43) Pub. Date: Jul. 9, 2026

(54) SYSTEMS AND METHODS FOR A SPACE LOGISTICS OPTIMIZATION MODEL

(71) Applicant: William Marsh Rice University, Houston, TX (US)

(72) Inventors: Marco Salmaso, Houston, TX (US); Mark Jernigan, Houston, TX (US); Leonardo Dueñas-Osorio, Houston, TX (US)

(21) Appl. No.: 19/442,779

(22) Filed: Jan. 7, 2026

Related U.S. Application Data
(60) Provisional application No. 63/742,776, filed on Jan. 7, 2025.

(51) Int. Cl. G05D 1/644; G06F 30/20; G06F 111/04

(52) U.S. Cl. CPC G05D 1/644; G06F 30/20; G06F 2111/04

(57) ABSTRACT

The present technology pertains to a system for optimizing space logistics for multi-part space missions. Space logistics are optimized by selecting a combination of space vehicles and space maneuvers performed by those space vehicles that maximize the destination mass while simultaneously minimizing the initial mass, as well as minimize mission delta-v and costs. This optimization can be performed using an objective function as a weighted combination of the destination mass and the corresponding initial mass. This optimization can be subject to various constraints, including system compatibility, operational feasibility, lower and upper bounds for the variables, mass balance at each node, inflow-outflow relationship, rocket capacity constraints, and non-negativity applied to the flow.

### CROSS REFERENCE TO RELATED APPLICATIONS

This is a U.S. Non-Provisional patent application that claims benefit to U.S. Provisional Patent Application Ser. No. 63/742,776 filed on Jan. 7, 2025, which is herein incorporated by reference in its entirety.

### GOVERNMENT SUPPORT

This invention was made with government support under 80NSSC19M0186 awarded by the National Aeronautics and Space Administration. The government has certain rights in the invention.

### FIELD

The present disclosure generally relates to determining space logistics for multi-part space missions, and, more particularly, to optimizing space logistics for multi-part space missions.

### BACKGROUND

Defined by the AIAA Space Logistics Technical Committee as “the theory and practice of driving space system design for operability and supportability, and of managing the flow of materiel, services, and information needed throughout a space system lifecycle,” space logistics has emerged relatively recently as a critical aspect of aerospace engineering research, comprising a range of activities, from campaign analysis to resupply operations and in-space refueling, to asset management and transportation of crew, cargo, resources, and data across various nodes and destinations during the entire duration of space missions.

Directly related to the definition of space logistics is the concept of transportation Asset Class (AC), representing all the components associated with space missions and incorporating both existing and conceptualized assets to enhance the supply chain's resilience. ACs include an architecture network with nodes and trajectories, launch vehicles, spacecraft, landers, space and ground infrastructures, and other related technologies, as well as the involvement of government space agencies and private space companies.

The main purpose of space logistics at the interplanetary level is to optimize the flow of resources or commodities into a given network or architecture, with the aim of minimizing transportation costs, mitigating mission risk due to logistics failures, and ensuring the sustainability and efficiency of operations for establishing a long-term human presence in space.

It is with these observations in mind, among others, that various aspects of the present disclosure were conceived and developed.

### SUMMARY

The present disclosure provides a number of examples that describe computer-implemented techniques and operations for space flight and logistics optimization. In the context of the disclosed methods, devices, techniques, apparatus, systems, and so on, the terms “operable to,” “configured to,” and “capable of” used herein are interchangeable.

In one set of illustrative examples, the computer-implemented techniques and operations are embodied by a method of planning and optimizing logistics for space travel by evaluating different combinations of space vehicles and mission maneuvers. The method identifies a set of vehicles to execute a predefined mission from an origin location to a destination location and identifies a corresponding set of maneuvers that includes launching from an originating celestial body to an intermediate position (for example, low Earth orbit, an Earth parking orbit, a lunar near-rectilinear halo orbit, or an Earth-lunar Lagrange point). For a candidate combination, the method determines (i) an initial mass of the selected vehicles at the intermediate position (which may include vehicle mass, propellant, passengers, and cargo) and (ii) a destination mass delivered to the destination location. The method repeats these determinations for multiple candidate combinations of vehicles and maneuvers, and selects a combination that maximizes delivered destination mass while minimizing the corresponding initial mass. In some embodiments, the method also determines an aggregated cost for a candidate combination, including vehicle costs, maintenance costs, and maneuver costs. In some embodiments, the selection is performed by optimizing an objective function that weights destination mass and initial mass, and integer linear programming is used to determine an optimal combination subject to constraints such as system compatibility, operational feasibility, input bounds, mass balance at mission nodes, flow conservation, vehicle capacity, and non-negativity constraints. In some embodiments, statistical analysis is applied to the optimization, including Monte Carlo simulation. In some embodiments, the mission maneuvers include launch to an Earth parking orbit, refueling at an Earth parking orbit, a trans-lunar injection trajectory, and descent to low lunar orbit. In some embodiments, the vehicles include lunar cyclers, reusable orbit transfer vehicles, landers, and tankers, and may include both publicly sourced and privately sourced vehicles.

In another set of illustrative examples, the inventive concept can take the form of a method that generates a feasible logistics plan for a multi-part space mission by building and solving a mission logistics model that represents the mission architecture as a directed network. The method receives mission definition data specifying at least an origin location, a destination location, one or more commodities to be transported (such as crew, cargo, propellant, life-support resources, or other payload items), and one or more mission objectives. The method constructs and stores a logistics network model having nodes that represent orbital and/or surface locations and arcs that represent candidate trajectories between nodes. Each arc can be associated with technical parameters including a required delta-v and one or more capacity limits.

In some embodiments, the method computes propulsion feasibility for at least one candidate trajectory by calculating an available delta-v using propulsion parameters, including specific impulse, and a mass history for one or more propulsion stages that includes initial mass and final mass. In some examples, the available delta-v is computed using a rocket-equation-based calculation that sums stage contributions, with stage-specific impulse values selected based on whether a stage operates in atmosphere or vacuum. In some embodiments, feasibility constraints require that the available delta-v for a trajectory satisfies the required delta-v for that trajectory, and for launch trajectories the feasibility determination can account for Earth rotational boost and losses due to atmospheric drag and gravity.

In some embodiments, the method formulates an optimization problem using decision variables that represent which space vehicles are selected to traverse particular trajectories and how quantities of the commodities are assigned to the selected trajectories. The optimization is constrained by technical constraints including mass balance at nodes, flow conservation across the network, vehicle capacity limits, and delta-v feasibility constraints, and can optionally account for propellant losses such as boil-off during storage and/or transit. In some embodiments, the optimization is solved using integer linear programming to determine an optimal combination of vehicles and commodity flows that satisfies the constraints and meets the mission objective, such as minimizing initial mass delivered to a designated staging orbit while maximizing mass delivered to the destination location.

In some embodiments, the method generates and stores a mission logistics plan data structure that specifies the selected vehicles, a sequence of selected trajectories defining a maneuver schedule between nodes, and the quantities of commodities assigned to those trajectories for transport to the destination location. In some embodiments, the method additionally produces one or more mission performance metrics from the solved plan, such as a total number of launches, total mission delta-v, total mission cost, and total mass delivered to an intermediate node and/or the final destination.

In some embodiments, the method performs a reliability analysis that accounts for uncertainties in mission parameters by applying statistical simulation, including Monte Carlo simulation, to uncertain parameters such as payload uncertainty, propellant boil-off uncertainty, launch turnaround time, and/or launch success probability. In some examples, launch success or failure is modeled using a Bernoulli process and one or more uncertainties are modeled using a normal distribution. The reliability analysis can determine a minimum number of launches needed to achieve a replenishment success probability meeting or exceeding a predefined threshold, and the mission logistics plan can be updated accordingly. In some embodiments, the mission logistics plan is output for display and/or provided to a mission planning system to support scheduling of refueling operations and vehicle maneuvers.

In other embodiments, a logistics-planning method includes selecting a plurality of space vehicles and a plurality of space maneuvers to realize a predefined space mission, determining a destination mass delivered to a destination location from an intermediate position, and selecting a combination of vehicles and maneuvers that simultaneously minimizes a mass at the intermediate position while maximizing the destination mass (e.g., via multi-objective optimization).

In some embodiments, the planning includes determining an aggregated delta-v for performing a set of maneuvers using a selected set of space vehicles.

In some embodiments, statistical analysis is applied in connection with optimization (including Monte Carlo simulation).

In some embodiments of the computer-readable medium and/or computing apparatus implementations, the intermediate position includes LEO, NRHO, an Earth-lunar Lagrange point, and/or an Earth parking orbit, and a mass at the intermediate position includes space-vehicle mass, propellant mass, passenger mass, and cargo mass.

In some embodiments of the computer-readable medium and/or computing apparatus implementations, an aggregated cost is determined for a candidate combination, including total vehicle cost, maintenance cost, and maneuver cost.

In some embodiments, the objective function is a weighted combination of destination mass and corresponding initial mass.

In some embodiments, optimization constraints further include a lower bound on delta-v such that a planned delta-v exceeds a required delta-v by a predefined margin.

In some embodiments, the selected space vehicles include public-sourced and private-sourced space vehicles.

Other illustrative examples are contemplated including computer-readable media, etc. The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is an illustration of assumptions associated with examples of an optimization model described herein.

FIG. 2 is an illustration of an optimization algorithm defined by the optimization model using linear programming as described herein.

FIG. 3 is an illustration of example logistics for a scenario of a space mission in accordance with some examples including an Artemis III/SpaceX architecture scenario.

FIG. 4 is an illustration of example logistics for a scenario of a space mission in accordance with some examples including an Artemis V/Blue Origin architecture scenario.

FIG. 5 is an illustration of example logistics for a scenario of a space mission in accordance with some examples including a Lunar Cyclers architecture scenario.

FIG. 6 illustrates an example of logistics associated with another scenario of a space mission in accordance with some examples of the present disclosure.

FIG. 7 illustrates an example of a preliminary Earth-Moon-Mars model in accordance with some embodiments.

FIG. 8A is a grouped bar chart comparing a number of launches required for the plurality of mission architecture scenarios shown in FIGS. 3-5; wherein each architecture includes multiple bars representing expendable versus reusable configurations and single-mission versus multi-mission cases.

FIG. 8B is a grouped bar chart comparing mass metrics, including total mass and payload mass delivered to low Earth orbit and to a lunar destination, for one-mission and two-mission cases across the plurality of mission architecture scenarios of FIGS. 3-5.

FIG. 9A is a grouped bar chart comparing total mission delta-v, in kilometers per second, for the plurality of mission architecture scenarios of FIGS. 3-5, wherein each architecture includes bars corresponding to single-mission versus multi-mission scenarios and expendable versus reusable configurations.

FIG. 9B is a grouped bar chart comparing total mission cost, in billions of U.S. dollars, for the plurality of mission architecture scenarios of FIGS. 3-5, wherein each architecture includes bars corresponding to single-mission versus multi-mission scenarios and expendable versus reusable configurations.

FIG. 10 is a muti-series line graph illustrating mission failure probability as a function of a number of launch attempts for a plurality of launch-vehicle options, and further showing a threshold failure probability for comparison.

FIG. 11 is a horizontal bar chart comparing total mission cost, in billions of U.S. dollars, for a plurality of launch-vehicle options, wherein each cost corresponds to achieving a replenishment success probability at or above a predefined threshold (e.g., ≥99.63%).”

FIG. 12 is a line graph illustrating mission failure probability versus a number of launch attempts for a plurality of launch-vehicle options and/or uncertainty cases, thereby indicating a minimum reliable number of launches required to reduce mission failure probability below a selected threshold.

FIG. 13 is a graph illustrating failure probability (Log Scale) vs. a number of launch attempts for each launch vehicle, including nominal probability vs. uncertainty curves.

FIG. 14 is a bar chart showing launch cost with uncertainty bars for each launch vehicle, nominal vs. worst case scenario (payload+/−5% and boiloff+/−30% uncertainties).

FIG. 15 is a bar chart showing refueling duration with uncertainty bars, nominal vs. worst case scenario (payload+/−5% and boiloff+/−30% uncertainties).

FIG. 16 is an example of a computing device for executing various systems, methods, operations and the like described herein.

Corresponding reference characters indicate corresponding elements among the view of the drawings. The headings used in the figures do not limit the scope of the claims.

### DETAILED DESCRIPTION

### Abbreviations and Nomenclature

A=set of arcs
C=cost [USD]
D=drag force [N]
[symbol] =objective function
g₀=standard gravitational acceleration [m/s²]
Isp=specific impulse [s]
i=initial node
j=arrival node
k=number of commodities
L=total number of launches
l=launch index
M=total mass [kg]
m₌₀=initial mass before propellant burn [kg]
m_{f}=final mass after propellant burn [kg]
\dot{m}=propellant burn rate [kg/s]
N=set of nodes
n=stage index
R=set of rockets and space vehicles
R_{E}=radius of the Earth [km]
r=rocket index
S=total number of stages
T=rocket thrust [N]
t=burn time [s]
t₀=starting time of the burn [s]
t_{f}=ending time of the burn [s]
w=weight associated with a commodity
x=quantity of a commodity
γ=flight path angle [rad]
ΔV=change in velocity [km/s]
θ_{orb}=orbital inclination [rad]
λ=geocentric latitude [rad]
ω_{E}=angular velocity of the Earth [rad/s]

The present disclosure relates to optimizing space logistics for space exploration. Deep space exploration has evolved significantly, increasing in complexity. This change is characterized by a shift from relatively simplistic, single-shot missions and targeted endeavors with limited objectives to fully integrated campaigns involving multiple celestial bodies, long-duration missions, diverse payload requirements, and numerous combinations of launch windows and suitable vehicles tailored to specific needs. Along with the multidimensional complexity of the mission scenarios, concerning variables such as timing, resource allocation, and technological capabilities, all on an unprecedented scale, the deployment of cutting-edge technologies has redefined supply chain logistics for interplanetary missions. The integration of emerging systems and novel assets, including the introduction of reusable rocket boosters, advancements in commercial low-Earth orbit (LEO) operations, and the potential incorporation of lunar infrastructure (e.g., the Lunar Gateway and lunar outposts), introduce new variables and uncertainties to the supply chain management across Earth, the Moon, and Mars.

To achieve this goal, it is important to understand and solve different challenges. The systems and methods disclosed herein enable deep space exploration by enabling a robust and administratively manageable determination of a combination of space vehicles and space maneuvers that achieve the mission objectives with optimal efficiency (e.g., delivery of the largest mass to the destination with the lowest initial mass and/or the lowest cost. This is achieved using a space logistics optimization model, capable of producing different architectures to accommodate the diverse requirements for deep space exploration (e.g., missions to the Moon and/or Mars), from small exploratory missions to large-scale commercial endeavors, and adaptable to ensure resilience and responsiveness to evolving space mission scenarios and destinations.

The model includes a novel approach in combining public-private assets for space exploration logistics, while considering all potential asset classes involved in Artemis missions (e.g., launch vehicles, spacecraft, landers, crew habitats, etc.). Particularly, the formulation incorporates contributions to the logistics of many existing technologies and emerging innovative systems under development, such as In-Situ Resource Utilization (ISRU) and the Lunar Gateway, alongside conceptual and potential future space infrastructure, including lunar cyclers and LEO commercial stations and support assets. These technologies are modeled based on their current capabilities or projected performance capability, with adjustable parameters for potentially needed systems to account for varying assumptions.

The systems and methods disclosed herein provide models and optimization techniques that can enhance space mission design and decision-making processes. The systems and methods disclosed herein have the benefit of providing an end-to-end logistics optimization model to address the inefficiencies in current state-of-the-art Earth-dependent supply chains and enable sustainable space exploration. The model can determine optimal architectures for space missions (e.g., the Artemis missions) and interplanetary endeavors, in support of NASA, the commercial space sector, and the U.S. Space Force. The systems and methods disclosed herein can be used with or without SpaceNet, an MIT-NASA for modeling and simulation environment. The systems and methods disclosed herein can be used to design lunar scenarios encompassing network, assets, and operations, along with the development of algorithms to compute orbital mechanics parameters and implement integer linear programming for optimization. The systems and methods disclosed herein beneficially include such improvements as minimizing mass to low-Earth orbit, maximizing payload delivery to destination, reducing total delta-v, and lowering mission costs.

As a point of reference, the systems and methods disclosed herein are illustrated using the example of the Apollo 11 profile as the baseline for human spaceflight. Further, the model is illustrated by applying it to optimize three main scenarios, each evaluated for single and sequential crewed missions: Artemis III (SpaceX), Artemis V (Blue Origin), and the Lunar Cyclers architecture. These examples illustrate the benefits of the systems and methods disclosed herein for analyzing trade-offs among advanced In-Situ Resource Utilization (ISRU), propulsion technologies including reusable and expendable boosters, and in-orbit depot selection across the mission lifecycle. Results reveal that cyclers could represent a lower-cost alternative for sustained lunar campaigns, with ISRU emerging as the most efficient refueling strategy over Earth-based resupply launches, and asset reusability demonstrating further reductions in operational expenses. By creating a decision support tool for space logistics, the systems and methods disclosed herein provide resilient, cost-effective, and adaptable solutions for future space exploration, contributing to making humanity a multi-planetary species.

The systems and methods disclosed herein provide advancements over space mission planning that primarily focuses on direct supply missions from Earth, i.e. point-to-point transportation models based on Earth-to-orbit or orbit-to-orbit single-use or short-term missions, with limited infrastructure for extensive interplanetary missions. The approach of on direct supplying missions from Earth presents significant disadvantages and limitations: inefficiencies from the lack of integrated logistics networks, high costs due to the dependence on Earth-based supplies and disposable propulsion assets, limited mission adaptability and scalability due to the large number of required launches and compatibility requirements, and increased risks from the lack of resilience against uncertain conditions and of in-space servicing and repair capabilities. To resolve these challenges, the systems and methods disclosed herein provide a way to develop a space logistics optimization model, capable of producing different architectures to accommodate the diverse requirements of both Moon and Mars missions, from small exploratory missions to large-scale commercial endeavors, and adaptable to ensure resilience and responsiveness to evolving space mission scenarios and destinations.

The systems and methods disclosed herein provide an optimization algorithm that is applied to maximize the efficiency of Artemis missions' architectures and lunar exploration initiatives beyond Artemis V. The algorithm involves orbital mechanics calculations and rocket equation implementation to compute orbital and mission parameters (e.g., mass history at each location, delta-v for each maneuver, etc.), and integer linear programming (ILP) as the optimization technique to determine the most effective combinations of technologies over time at each phase of the mission or campaign, adjusting the selection and resource flows based on mission constraints and goals.

The logistics optimization model incorporates contributions to the logistics of many existing technologies and emerging innovative systems under development, such as In-Situ Resource Utilization (ISRU) and the Lunar Gateway, alongside conceptual and potential future space infrastructure, including lunar cyclers and LEO commercial stations and support assets. These technologies are modeled based on their current capabilities or projected performance capability, with adjustable parameters for potentially needed systems to account for varying assumptions.

For respective scenarios, the results obtained by the optimization provide the best combination of technologies that minimize initial mass to LEO, maximize payload delivery to final destination, or both at the same time, and minimize delta-v and mission costs. By comparing the scenarios' optimized performance parameters with and without emerging assets such as the Lunar Gateway or lunar cyclers, the analysis evaluates their potential contributions to the overall mission success and provides information to support decision-making for future and planned assets and achieve the optimal strategy for the human lunar exploration architecture.

The systems and methods disclosed herein build on previous work related to transportation Asset Class (AC), representing all the components associated with space missions and incorporating both existing and conceptualized assets to enhance the supply chain's resilience. ACs include an architecture network with nodes and trajectories, launch vehicles, spacecraft, landers, space and ground infrastructures, and other related technologies, as well as the involvement of government space agencies and private space companies.

Based on novel insights inspired by previous work on ACs that involved unmanned and crewed lunar exploration, the systems and methods disclosed herein develop a logistics optimization framework using ILP to evaluate trade-offs between cost, efficiency, and capability of Artemis missions' assets and potential future technologies (e.g., lunar cyclers, reusable orbit transfer functionalities, etc.). SpaceNet is used solely to generate graphics illustrating the optimized scenarios].

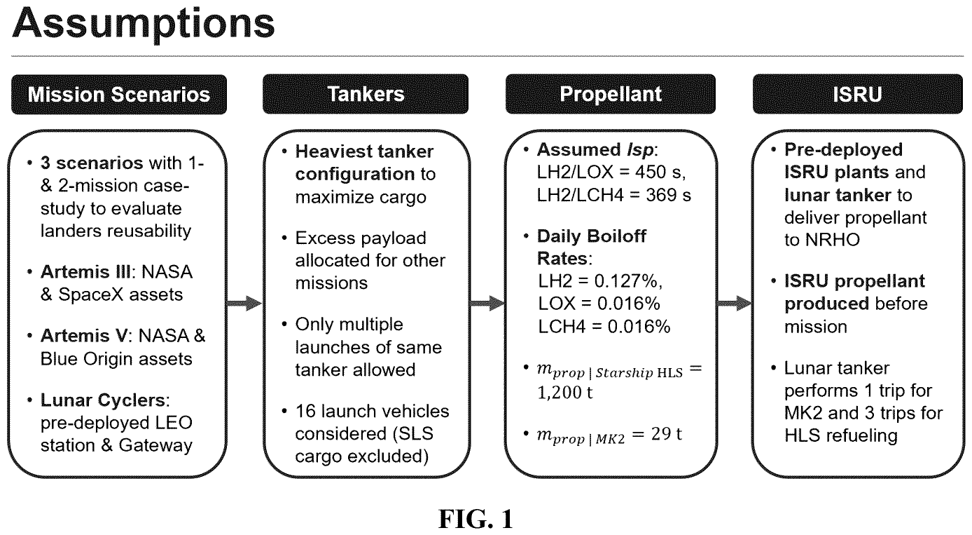

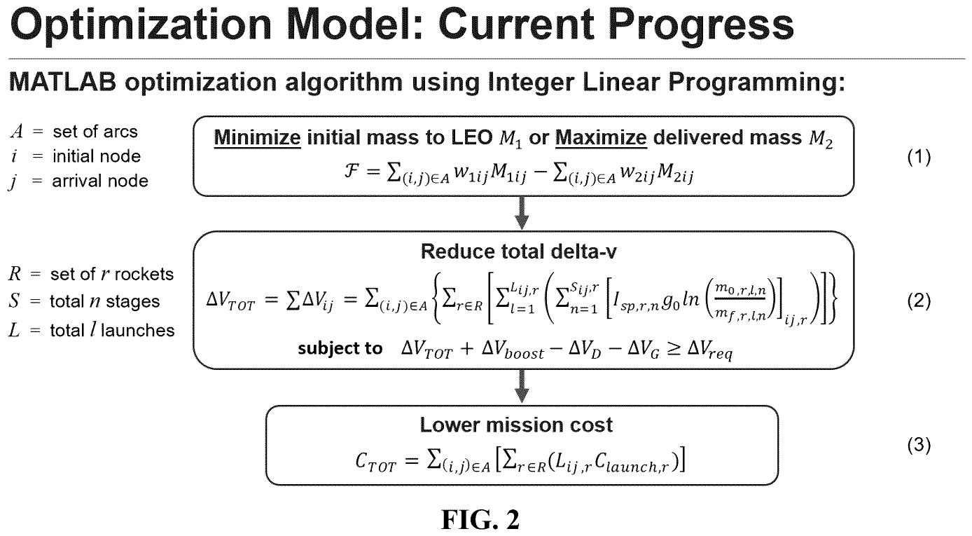

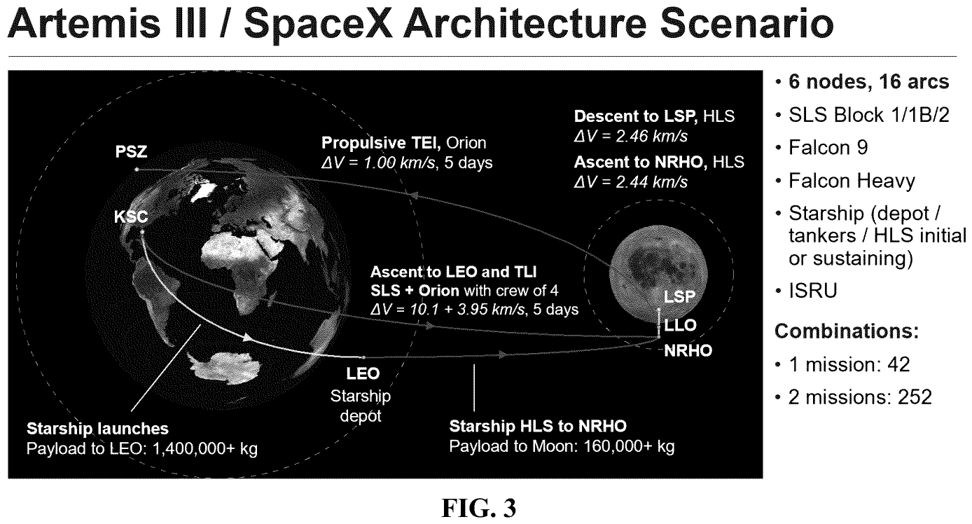

Below, the algorithm formulation (FIGS. 1-2), the lunar scenarios (FIGS. 3-5), and the optimization results are described, providing insights on the most effective approach for commodity transport to designing an efficient lunar exploration framework.

FIG. 1 illustrates example assumptions, and FIG. 2 illustrates an example implementation of the algorithm formulation of the model. The model is developed to integrate any current or future technology, taking as inputs: the initial masses (dry mass, propellant mass, payload mass) of rockets, spacecraft, landers, or other space vehicles involved in the architecture; propulsion system parameters, comprehending rocket's sea level and vacuum specific impulses (Iₛₚ), thrust (T), or delta-v if known; cost per single launch and cost-per-unit of resources or consumables flowing into the network; additional inputs such as the quantity and types of commodities, including estimates for uncertain parameters via lower and upper bounds. If the exact value of a certain input is not available from the literature, estimations derived from orbital mechanics or pre-defined ranges are calculated and integrated into the framework.

Outputs of the algorithm comprise the total mass (inflow and outflow) in each node of the given architecture, the total delta-v and mission cost, the total number of launches, and the technologies that best maximize resource efficiency at each mission phase. Firstly, the total mass at a certain node of the network is calculated by summing all the mass components delivered by launch vehicles, spacecraft, or landers at a location, including dry mass, residual propellant mass, cargo mass, as well as transfer stages, in-orbit propellant tanks, space taxis, and other auxiliary systems mass. The calculation also accounts for reusable and expendable systems in case of multiple missions.

Secondly, the total delta-v ΔV_{TOT} is derived from the sum of the single delta-v for each maneuver, computed based on trajectory type, payload mass carried, rocket design, and environmental factors, which comprise the celestial bodies' gravity, atmospheric drag, and planetary alignment. The mathematical formulation for the mission's total available delta-v, incorporating the Tsiolkovsky rocket equation, is provided by the following Eq. (1):

$$Δ {V}_{T O T} = \sum {ΔV}_{ij} = {\sum }_{( i , j ) ∈ A} \{ {\sum }_{r ∈ R} [ {\sum }_{l = 1}^{{L}_{ij , r}} ( {\sum }_{n = 1}^{{S}_{ij , r}} {[ {I}_{sp , r , n} {g}_{0} ln ( \frac{{m}_{0 , r , l , n}}{{m}_{f , r , l , n}} ) ]}_{ij , r} ) ] \} \qquad ( 1 )$$

Summing the contributions from all stages n involved in a maneuver, executed in l launches by r propulsion systems from the set R of assets available, the ΔVᵢⱼ represents the individual delta-v for each arc (i,j) that belongs to a set A of arcs and connects initial nodes i to arrival nodes j. Each stage n has its own initial and final mass (m_{0,n} and m_{f,n}), with the m_{f,n} of one stage becoming the m_{0,n+1} of the next stage, thus reflecting discarded mass during staging.

The specific impulse I_{sp,r,n} is selected based on the environment, meaning I_{sp,r,n}=I_{sp,sea level} for first stage and atmospheric operations, and I_{sp,r,n}=I_{sp,vacuum} for subsequent stages operating in vacuum and space maneuvers. Equation (1) accommodates scenarios where different launches or propulsion events l are required to complete a mission. For example, for the ascent to LEO trajectories, Lᵢⱼ identifies the total number of launches needed to refuel a depot in Earth orbit, whereas for LEO to Moon orbit routes it may represent a reusable taxi making multiple trips or separate trajectories for crew and cargo.

Thirdly, the total cost C_{TOT} is determined from multiplying Lᵢⱼ to the cost per single launch for a specific rocket r, assuming that C_{launch,r} includes operational and commodities costs, and considering the impact of systems reusability, network design, and mission duration. Equation (2) shows the expression for the total mission cost:

$${C}_{T O T} = {\sum }_{( i , j ) ∈ A} [ {\sum }_{r ∈ R} ( {L}_{ij , r} {C}_{launch , r} ) ] \qquad ( 2 )$$

The optimization algorithm is designed with multiple objectives to enhance performance parameters. A primary goal consists of minimizing the initial mass carried to LEO as a figure of merit for the cost of the mission and serving as a key metric for affordability, given that lower masses delivered to Earth orbit directly correlate with reduced launch costs. The formulation also proposes to maximize payload delivery to the destination—specifically the Lunar South Pole (LSP)—thereby improving exploration capabilities, increasing scientific return, and bolstering redundancy, mission duration, and success rate. Furthermore, the algorithm aims to reduce total delta-v, and consequently, fuel consumption, minimize operational expenses, and mitigate mission risks, enhancing the resilience of the baseline architecture and assets, and enabling robust campaign planning. Lastly, the model determines the most efficient combination of technologies that achieves these objectives, both individually and collectively, for a single mission and for two consecutive crewed missions within each architecture.

A cost-benefit comparative analysis evaluates the performance of the various technologies, comparing the results and their effectiveness against the best configurations for other scenarios and state-of-the-art expendable launches. The inclusion of two sequential missions emphasizes the importance of testing system reusability, such as the Starship Human Landing System (HLS) or the Blue Moon lander, to quantify the cost savings and operational advantages they bring to the overall architecture.

The algorithm's general mathematical formulation can define the optimal flow of k commodities across a network of a set N of nodes is represented by:

$$ℱ = {\sum }_{( i , j ) ∈ A} {w}_{i j} {x}_{i j} \qquad ( 3 )$$

Equation (3) shows the weights wᵢⱼ (e.g., cost-per-unit) multiplied by xᵢⱼ, representing the quantity of a certain commodity or resource moving into the network. This expression's goal is to minimize or maximize the objective function [symbol] , which is a weighted sum of the decision variables of the optimization problem.

In the case of minimizing initial mass and maximizing final mass, the weighted objective function's formulation becomes:

$$ℱ = {\sum }_{( i , j ) ∈ A} {w}_{1 i j} {M}_{1 i j} - {\sum }_{( i , j ) ∈ A} {w}_{2 i j} {M}_{2 i j} \qquad ( 4 )$$

In Eq. (4), the xᵢⱼ decision variables are the masses of space vehicles transported through the network. Specifically, M₁ᵢⱼ indicates the total initial mass in LEO, including dry mass, any remaining propellant, and cargo, whereas M₂ᵢⱼ represents the total final mass at the destination, consisting of dry mass, residual propellant, and the delivered payload. A boil-off factor is also considered to account for losses due to evaporation during storage and transit in space. In addition, cargo comprehends all types of payloads, such as scientific instrumentation for lunar missions, the Environmental Control and Life Support System (ECLSS), crew members, propellant for in-space refueling, and other mission-critical items.

The coefficients w₁ᵢⱼ and w₂ᵢⱼ correspond to the weights assigned to minimizing M₁ᵢⱼ or maximizing M₂ᵢⱼ, respectively. Setting w₁ᵢⱼ=0 highlights the combination of technologies that only maximizes final mass, whereas w₂ᵢⱼ=0 identifies the approach that only minimizes initial mass in LEO. When both weights are nonzero, the optimization balances the competing objectives to determine the most effective trade-off between maximizing delivered mass and minimizing initial mass.

Equations (3) and (4) are subject to several constraints that are integrated into the algorithm, including system compatibility, operational feasibility, lower and upper bounds for the variables, mass balance at each node, inflow-outflow relationship, rocket capacity constraints, and non-negativity applied to the flow. One of the most important constraints, affecting the feasibility of an architecture, imposes that the ΔV_{TOT} derived in Eq. (1) must be greater, with some margins, than the required delta-v to reach a destination, considering the effects of Earth rotational boost (ΔV_{boost}), atmospheric drag (ΔV_{D}), and gravity losses (ΔV_{G}). This condition is expressed by Eq. (5) below:

$$Δ {V}_{TOT} + Δ {V}_{boost} - Δ {V}_{D} - Δ {V}_{G} \geq Δ {V}_{req} Δ {V}_{TOT} + {R}_{E} \cdot {ω}_{E} \cdot cos ( λ ) \cdot cos ( {θ}_{orb} - λ ) - {\int }_{{t}_{0}}^{{t}_{f}} \frac{D ( t )}{{m}_{0} - \dot{m} \cdot t} dt - {\int }_{{t}_{0}}^{{t}_{f}} {g}_{0} \cdot sin ( γ ( t ) ) dt \geq Δ {V}_{req} , \qquad ( 5 )$$

wherein ΔV_{boost}, ΔV_{D}, and ΔV_{G} are relevant for the initial launch only, and negligible for post-LEO maneuvers. ΔV_{req} is dependent on the specific trajectory and has been calculated using orbital mechanics relations and the patched conic approach when related to transfers between different celestial bodies.

Various assumptions can be used with the model. For example, these assumptions can be outlined below. For example, the assumptions can be considered for each architecture and for the optimization problem. In the scenario reproducing the Artemis III profile, only NASA and SpaceX technologies are used across the network, whereas the Artemis V scenario involves only NASA and Blue Origin assets. For the third and fourth architectures, the Lunar Gateway is assumed to be completely assembled and fully operational performing a Near-Rectilinear Halo Orbit (NRHO) around the Moon. In the last architecture, the cycler is supposed to be already orbiting the Earth-Moon system, a cislunar transporter shuttling between a fully functioning LEO station and the Lunar Gateway, and a lunar tanker carrying propellant from LSP to Moon orbit, with a taxi vehicle utilized to transfer mission assets back and forth.

All the optimized scenarios assume pre-deployed ISRU plants on the Moon for oxygen production and water extraction from lunar regolith, with the ability to perform electrolysis on the extracted water. Additionally, the production is considered complete before the mission launches and sufficient to meet mission demands without causing delays. Previously delivered to NRHO via a Starship launch, a single lunar tanker traveling between the Moon's surface and the Lunar Gateway with ISRU-produced propellant is assumed to complete one (scenario 3) to three refueling trips (scenarios 2 and 4) to satisfy the propellant needs for the two-mission case study, and can be reused for all the trips without requiring significant refurbishment.

For rockets whose specific impulse is not publicly available, the I_sp of the LH2/LOX and LH2/LCH4 are assumed 450 s and 369 s, respectively. The daily boiloff rates are estimated to be 0.127% for liquid hydrogen and 0.016% for both liquid oxygen and liquid methane, reflecting losses due to the imperfect thermal insulation of storage tanks. All tanker vehicles are selected in their heaviest configuration, designed to carry the maximum cargo they are capable of transporting in order to test their full capability and maximize exploration potential, hypothesizing that any payload in excess is allocated for future missions. Furthermore, only multiple launches of the same tanker are permitted per phase, excluding unlikely combinations involving rockets from different companies. The Space Launch System (SLS) cargo variant is never included as a tanker option due to its high costs.

Lastly, for the Starship depot and the cislunar transporter, it is assumed the total refuel capability exceeds the required amount to replenish the landers and that the additional propellant is used for the second crewed mission.

### Lunar Logistics Scenarios

Modeled scenarios comprise the Apollo 11 design reference profile or Direct to Moon scenario, considered as the human spaceflight baseline for the analysis, the Artemis III architecture or SpaceX supply chain scenario, the Artemis V or Blue Origin architecture, and the Lunar Cyclers architecture. In the first scenario, mass history, total delta-v, and mission costs have been calculated based on the data available on the NASA Apollo Missions historical archive. The subsequent architectures have been refined and optimized, starting from the baseline design reference architectures (DRA) for Artemis III and Artemis V, conceptualizing and developing variations for each model that integrate a number of technologies, including contributions from international partners.

The optimization includes a case study with two consecutive crewed missions to evaluate the reusability of HLS or the Blue Moon lander compared to direct-to-moon expendable launches and how this impacts overall costs. In the context of two missions, each scenario integrates a lunar propellant facility (ISRU) that can produce methane and liquid oxygen from water ice and other regolith resources, and a lunar tanker to shuttle propellant from the Moon's surface to NRHO for refueling the lander. In this case, Starship HLS or the Blue Moon lander do not need to be launched again from Earth but are already placed in NRHO after the first crewed mission and reusable through either Earth-based or ISRU-derived refueling.

### Scenario 1: Apollo 11 Mission Architecture

The first architecture implements the Apollo 11 mission profile, with a sequential non-reusable design and no complex multi-step docking or in-orbit refueling procedures used in modern mission concepts. This straightforward approach, focused on simplicity and reliability, involves a direct trajectory to the Moon, from launch to lunar landing, return to lunar orbit, and finally back to Earth, without recurring to previously used stages or incorporating new modules, minimizing mission risk and operational complexity.

In Apollo 11, the primary objective was to achieve a crewed lunar landing and a safe return to Earth. The mission consisted of carrying three astronauts to the Moon and back, with two crew members landing on the lunar surface. The Saturn V Moon rocket, with three main stages, powered the journey. Each stage sequentially burned its engines until it was out of fuel and then separated from the vehicle to decrease the weight to be lifted, allowing the rocket to continue into space. Only the Command Module (CM) with the crew returned to Earth at the end of the mission.

The first stage lifted the rocket to an altitude of 61 km, and the second stage propelled it further into the upper atmosphere, reaching 185 km, before both stages fell into the Atlantic Ocean. Saturn V's third stage then boosted the spacecraft into Earth parking orbit (EPO). About two hours and a half later, after safety and trajectory checks, the third stage's J-2 engine restarted, sending the spacecraft out of Earth orbit into a Trans-Lunar Injection trajectory (TLI) with a second burn.

On the way to the Moon, the Command and Service Module (CSM) turned around to dock with the Lunar Module (LM), stowed inside the Spacecraft-LM Adapter (SLA). The coupled spacecraft entered Moon orbit performing a Lunar Orbit Insertion (LOI) maneuver and circularization. At this point, the third stage was jettisoned, ultimately crashing onto the Moon or entering orbit around the Sun. In LLO, at approximately 100 km of altitude from the lunar surface, the Commander (Neil Armstrong) and the LM Pilot (Buzz Aldrin) transferred to the LM, which separated from the CSM and descended to the Moon surface, performing a Descent Orbit Insertion (DOI) burn towards the landing site at Mare Tranquillitatis (MT). The third astronaut (Michael Collins) remained in lunar orbit aboard the CSM.

When surface activities ended, the LM ascent stage lifted off and docked with the CSM, where the crew reunited. Following this, after releasing the ascent stage, the CSM headed to Earth by executing a Trans-Earth Injection (TEI) maneuver. In the final phase, the SM was jettisoned and the crew of three reentered the atmosphere aboard the CM, slowed down by parachutes to land in the Pacific Splashdown Zone (PSZ). The mission successfully returned to Earth 21.55 kg of lunar samples for scientific study.

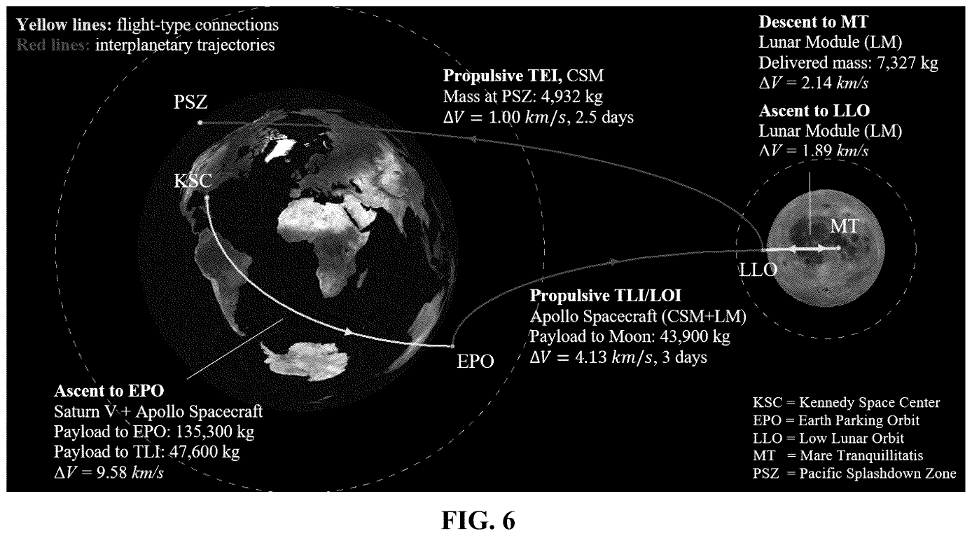

FIG. 6 illustrates the above-described Apollo 11 architecture, which is modeled using 5 nodes and 5 arcs. Although technically proven and successful during the Apollo missions, this scenario is not feasible in modern times due to obsolescence. The Saturn V is no longer under production and the CSM and LM are outdated by today's standards, with modern spacecraft design offering greater safety and efficiency. Given these considerations, the Apollo 11 architecture remains a valuable reference for human exploration and its legacy continues to inform advancements in mission planning, spacecraft design, and operational strategies.

In summary, the Apollo 11 mission profile can be used as the baseline model, with a sequential non-reusable design and no complex multi-step docking or in-orbit refueling procedures used in modern mission concepts. This straightforward approach, focused on simplicity and reliability, involves a direct trajectory to the Moon, from launch to lunar landing, return to lunar orbit, and finally back to Earth, without recurring to previously used stages or incorporating new modules mid-mission, minimizing mission risk and operational complexity.

The Apollo 11 mission profile includes:
NETWORK: 5 nodes, 5 arcs.
TECHNOLOGY: launch vehicle (Saturn V with 3 stages), spacecraft (CSM+LM), lunar lander (LM).
MISSION PHASES:
   Phase 1: A crew of 3 is launched with Saturn V (First Stage, Second Stage, Third Stage first burn) from Kennedy Space Center (KSC) to Earth Parking Orbit (EPO).
   Phase 2: Command and Service Module (CSM)+Lunar Module (LM) perform a propulsive Trans-Lunar Injection (TLI) to low lunar orbit (LLO) using Third Stage second burn.
   Phase 3: LM with 2 astronauts descends to Mare Tranquillitatis (MT). CSM with 1 astronaut remains in LLO.
   Phase 4: LM with 2 astronauts and lunar samples ascends to CSM. LM descent stage is left on the Moon and LM ascent stage is released once the 2 crewmen transfer to CSM.
   Phase 5: CSM performs a propulsive Trans-Earth Injection (TEI) for the return trip. SM is released before entering Earth's atmosphere and only CM with 3 astronauts lands at Pacific Splashdown Zone (PSZ).

### Scenario 2: Artemis III/SpaceX Mission Architecture

The second scenario reproduces the Artemis III Architecture, which consists of an adaptation of SpaceX Mars mission profile to the Moon. The initial phase begins with the launch of a Starship storage depot to LEO, which acts as a refueling hub for the subsequent operations. According to Space X, a minimum of 4 launches of the Starship tanker variant will be required to replenish the depot's fuel supply, considering that 8 to 14 tanker launches were planned for Mars missions, whereas NASA estimates up to 20 launches and several months needed to complete this phase. Each tanker delivers methane and liquid oxygen to the depot, ensuring sufficient propellant is available to meet the mission requirements. Other launch vehicles such as Falcon 9 and Falcon Heavy, both in their expendable and reusable configurations, have been included in the analysis for the refueling phase. However, the number of launches increases due to their lower payload capacities compared to the Starship tanker.

Once the depot is fully fueled, Starship HLS in its initial or sustaining configuration is launched to LEO, where it docks with the depot to load its required fuel. After refueling, it departs LEO and performs a TLI, traveling to the NRHO around the Moon. An SLS rocket then launches to LEO the Orion spacecraft with a crew of 4 astronauts. From there, Orion performs a TLI maneuver to NRHO, where it docks with the Starship HLS.

At this point, the mission transitions to lunar surface operations. Two crew members (or four, if the HLS sustaining variant is used for the descent) transfer to Starship HLS and land at LSP to conduct exploration and scientific tasks.

After completing their 7-day surface activities, the two astronauts on the Moon ascend back to NRHO aboard Starship HLS, where they rejoin their colleagues aboard Orion. With all four crew members reunited, Orion departs NRHO and performs a TEI for the return trip. Approaching the Earth, it safely brings the crew back through the atmosphere during the re-entry phase. The mission concludes with a splashdown in the Pacific Ocean, completing the journey.

FIG. 3 illustrates the above-described Artemis III architecture, which is modeled with 6 nodes and a minimum of 11 arcs, depending on how many launches are accounted for refueling the depot.

In summary, this second model reproduces Artemis III Architecture, planned for no earlier than September 2026, which consists of an adaptation of SpaceX Mars mission profile for the Moon, leveraging the reusability of Starship stages to reduce costs and turnaround times. The mission begins with the launch and refueling of a Starship depot in low Earth orbit (LEO). Starship HLS is then launched and refueled by the depot, before continuing to the Moon's Near-Rectilinear Halo Orbit (NRHO). Following this, the SLS launches the Orion spacecraft with the crew aboard, traveling to NRHO to dock with Starship HLS. Once docked, two astronauts transfer to Starship HLS to conduct lunar surface operations, while the remaining crew members stay aboard Orion. After the surface mission, the astronauts return to Starship HLS, which ascends to NRHO to rendezvous with Orion. The crew reunites aboard Orion departing NRHO for the journey back to Earth. Starship HLS remains in NRHO, prepared to support future lunar missions.

In the two crewed missions variant of this model, ISRU is considered as one of the refueling options for the Starship HLS.

Assumptions for this mission include: (1) only NASA and SpaceX technologies are used in this architecture; (2) minimum to zero leakage is assumed for any inert propellant stored in the Starship depot to be used for the second mission; (3) ISRU and lunar tanker shuttling between LSP and NRHO are assumed deployed and fully operative, and the ISRU production is considered complete before the mission launches; and (4) all vehicles always carry the maximum cargo they are capable of transporting and/or the exact quantity of propellant to replenish the depot for lunar missions.
NETWORK: 6 nodes, minimum 11 arcs.
TECHNOLOGY: launch vehicles (Starship, SLS Block 1/1B/2 crew configuration), tankers (Falcon 9, Falcon Heavy, Starship, lunar tanker), spacecraft (Orion), lunar landers (Starship HLS initial, Starship HLS sustaining), ISRU.
MISSION PHASES:
   Phase 1: Starship storage depot launched to LEO and refueled by multiple launches of:
      Falcon 9 tankers (expendable or reusable versions)
      Falcon Heavy tankers (expendable, partially reusable, or reusable versions)
      Starship tankers (expendable or reusable versions)
   Note: The goal is to bring to LEO the minimum quantity of propellant for Starship HLS to reach NRHO and perform descent and ascent. Falcon 9, Falcon Heavy, and Starship have reusable first stages, reducing costs. Refueling may include more propellant if a second crew mission is scheduled.
   Phase 2: Starship HLS launched to LEO, refueled by the depot, and sent to NRHO. Alternatives:
      Starship HLS initial (2 astronauts to LSP)
      Starship HLS sustaining (4 astronauts to LSP)
   Phase 3: The crew of 4 is launched with SLS crew configuration+Orion to NRHO and docks with HLS. Alternatives:
      SLS crew configuration Block 1
      SLS crew configuration Block 1B
      SLS crew configuration Block 2
   2 to 4 crew members descend to LSP using HLS
   Phase 4: Crew ascends to NRHO and transfers to Orion which performs TEI for return trip. HLS remains in NRHO for future crewed missions
Total combinations for 1 mission (Baseline for Artemis III): 7×2×3×1=42 combinations
CONSECUTIVE CREWED MISSIONS:
   Phases 1, 2, 3, and 4 in the first mission. For the second mission, Starship HLS (initial or sustaining version) is already placed in NRHO and refueled by one of these options:
      Starship tankers, refueled in LEO by Starship storage depot—
      ISRU with lunar tanker
Phases 3 and 4 are then repeated as in the first mission.
Total combinations for 2 missions: 42×2×3=252 combinations

### Scenario 3: Artemis V/Blue Origin Mission Architecture

Blue Origin's architecture outlines the mission profile for Artemis V, marking the first lunar scenario to incorporate the Lunar Gateway. The Gateway serves as a hub for facilitating crew transfers, refueling operations, staging surface missions, and expanding lunar exploration capabilities for long-term sustainable activities on the Moon. This architecture leverages the reusability of New Glenn's first stage for multiple launches, a cislunar transporter carrying resources between Earth and Moon, and the Blue Moon lander, which constitutes the primary vehicle for transporting astronauts from NRHO to the lunar surface and remains docked to the Gateway for future crewed missions.

The first phase consists of launching the Blue Moon lander (MK2, crew version) to LEO aboard the New Glenn rocket. A separate New Glenn tanker then delivers propellant to refuel the lander, performing a TLI maneuver to NRHO and docking with the Lunar Gateway.

A cislunar transporter, or taxi vehicle, is launched to LEO aboard another New Glenn rocket. This spacecraft is designed to carry additional propellant to NRHO and transfer it to the lander, ensuring sufficient fuel for lunar surface operations and the return journey. Similarly to the Blue Moon lander, the cislunar transporter is also replenished in LEO by New Glenn tankers before executing a TLI burn to NRHO. For the two consecutive missions' variant, a reusable version of the cislunar taxi is integrated into a sustainable system and refilled at the Lunar Gateway with ISRU-produced propellant, transferring supplies between NRHO and the Earth and leveraging in-orbit refueling capabilities to reduce reliance on Earth-based launches.

A crew of 4 astronauts reaches the Lunar Gateway aboard the Orion, previously launched to LEO by the SLS, and transfers to the Blue Moon lander after the Orion docking maneuver with the Gateway. The Blue Moon lander, fully fueled and carrying 2 astronauts for surface missions, departs NRHO and descends to LSP. Once the surface activities are concluded, the crew ascends from the Moon to NRHO aboard the Blue Moon lander, which docks again with the Gateway, where the astronauts transfer back to the Orion spacecraft. Orion, remained docked to the Lunar Gateway during lunar operations, performs a TEI to return the crew safely to Earth, with splashdown at PSZ.

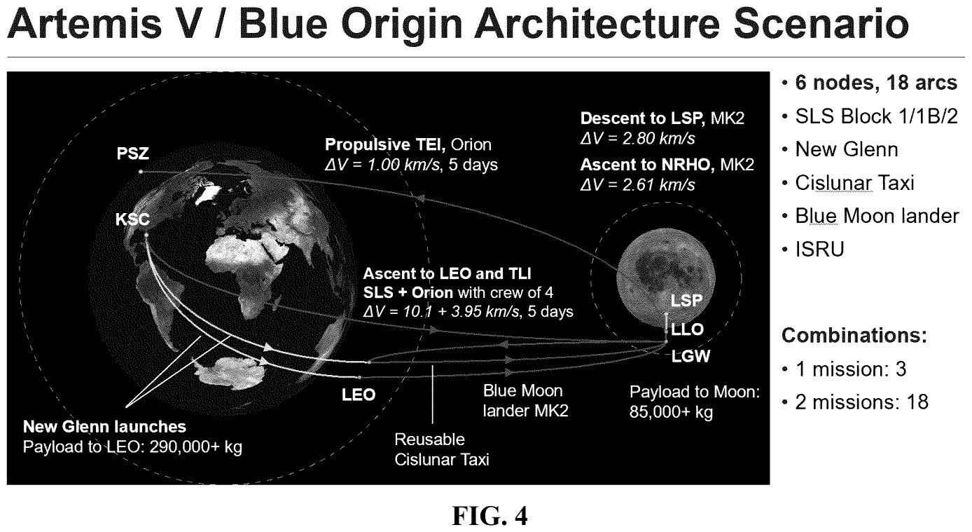

The network for the above-described Artemis V architecture is illustrated in FIG. 4, which involves 6 nodes and a minimum of 10 arcs based on the refueling launches considered for the cislunar transporter. Scenarios for this mission profile, assuming combinations between the Lunar Gateway and Starship HLS or other emerging technologies, were also developed.

In summary, the third model, in its first variant, represents Blue Origin's architecture and outlines the mission profile for Artemis V, scheduled for 2029, marking the first lunar architecture to incorporate the Lunar Gateway (LGW), a space station orbiting the Moon in NRHO. The Gateway serves as a hub for facilitating crew transfers, refueling operations, staging surface missions, and expanding lunar exploration capabilities for long-term sustainable activities on the Moon. This architecture leverages the reusability of New Glenn's first stage for multiple launches, a cislunar transporter carrying resources between Earth and Moon, and the Blue Moon lander which remains docked to LGW for future missions.

Other variants (3b and 3c) combine the LGW with other technologies such as Starship HLS and a LEO station for refueling.
ASSUMPTIONS:
   Only NASA and Blue Origin technologies are used in this architecture.
   LGW is assumed fully assembled and operational.
   Minimum to zero leakage is assumed for any inert propellant to be used for the second mission.
   For two crewed missions, ISRU and lunar tanker are assumed deployed and fully operative, and ISRU production rate is assumed to be sufficient to meet mission demands without causing delays.
   All vehicles always carry the maximum cargo they are capable of transporting and/or the exact quantity of propellant to replenish the cislunar transporter for lunar missions.
NETWORK: 6 nodes, minimum 10 arcs.
TECHNOLOGY: launch vehicles (New Glenn, SLS Block 1/1B/2crew configuration), tankers (New Glenn, cislunar transporter, lunar tanker), spacecraft (Orion), Lunar Gateway, lunar lander (Blue Moon lander MK2), ISRU.
MISSION PHASES:
   Phase 1: Blue Moon lander is launched to LEO by New Glenn, and refueled by multiple launches of New Glenn tankers. The goal is to bring to LEO the minimum quantity of propellant for the Blue Moon lander to dock with LGW. New Glenn has a reusable first stage, reducing costs.
   Phase 2: Cislunar transporter is launched to LEO by New Glenn, and refueled by multiple launches of New Glenn tankers. Again, the goal is to bring to LEO the minimum quantity of propellant for the cislunar transporter to dock with LGW and refuel the Blue Moon lander. Refueling may include more propellant if a second crewed mission is scheduled and the cislunar transporter needs to go back to LEO. Cislunar transporter then performs a TLI to LGW to refuel the Blue Moon lander
   Phase 3: The crew of 4 is launched with SLS crew configuration+Orion to NRHO and docks with Blue Moon lander at LGW. Alternatives:
      SLS crew configuration Block 1
      SLS crew configuration Block 1B
      SLS crew configuration Block 2
   2 to 4 crew members descend to LSP using the Blue Moon lander.
   Phase 4: The crew ascends to LGW and transfers to Orion which performs TEI for the return trip. The Blue Moon lander remains in NRHO for future crewed missions.
Total combinations for 1 mission (Baseline for Artemis V): 1×1×3×1=3 combinations
CONSECUTIVE CREWED MISSIONS:
Phases 1, 2, 3, and 4 in the first mission. For the second mission, the Blue Moon lander is already placed in NRHO and refueled by one of these options:
   Cislunar transporter, assuming it has enough fuel to come back again to LEO from LGW
   ISRU with lunar tanker
Phases 3 and 4 are then repeated as in the first mission.
Total combinations for 2 missions: 3×2×3=18 combinations
   MODEL 3b: Artemis V Architecture with Starship HLS and Other Technologies.
MISSION PHASES:
   Phase 1: A Starship storage depot or a post-ISS commercial LEO station are used as refueling hubs.
   If a starship storage depot is used, it may be refueled by multiple launches of:
      Falcon 9 tankers (expendable or reusable versions)
      Falcon Heavy tankers (expendable, partially reusable, or reusable versions)
      Starship tankers (expendable or reusable versions)
      ISRU via lunar tanker and cislunar transport coming from the Moon
   If the LEO station is used, it may be refueled by multiple launches of:
      Falcon 9 tankers (expendable or reusable versions)
      Falcon Heavy tankers (expendable, partially reusable, or reusable versions)
      Starship tankers (expendable or reusable versions)
      New Glenn tankers (expendable or reusable versions)
      Vulcan tankers (version with 6 SRBs)
      Atlas V 551 tankers
      Terran R tankers (expendable or reusable versions)
      Ariane 6 tankers (version with 4 SRBs)
      ISRU via lunar tanker and cislunar transporter
   Note: The goal is to bring to LEO the minimum quantity of propellant for Starship HLS to reach NRHO and perform descent and ascent. Falcon 9, Falcon Heavy, Starship, New Glenn, and Terran R have reusable first stages, reducing costs. Refueling may include more propellant if a second crew mission is scheduled.
   Phase 2: Starship HLS launched to LEO, refueled by the depot or the LEO station, and sent to LGW. Alternatives:
      Starship HLS initial (2 astronauts to LSP)
      Starship HLS sustaining (4 astronauts to LSP)
   Phase 3: The crew of 4 is launched with SLS crew configuration+Orion to NRHO and docks with LGW+HLS. Alternatives:
      SLS crew configuration Block 1
      SLS crew configuration Block 1B
      SLS crew configuration Block 2
   2 to 4 crew members descend to LSP using the Starship HLS.
   Phase 4: Crew ascends to LGW and transfers to Orion which performs TEI for the return trip. HLS remains docked with LGW for future crewed missions.
Total combinations for 1 mission: (8+15)×2×3×1=138 combinations
CONSECUTIVE CREWED MISSIONS:
Phases 1, 2, 3, and 4 in the first mission. For the second mission, Starship HLS (initial or sustaining version) is already docked with LGW and refueled by one of these options:
   Starship tankers, refueled in LEO by cislunar transporter or LEO station:
   LEO station via cislunar transporter
   ISRU with lunar tanker
Phases 3 and 4 are then repeated as in the first mission.
Total combinations for 2 missions: 138×3×3=1,242 combinations
   MODEL 3c: Artemis V architecture with Blue Moon lander and other technologies.
MISSION PHASES:
   Phase 1: Blue Moon lander is launched by New Glenn to LEO, and refueled by one of the following options before going to LGW.
   If a cislunar transporter is used to refuel the lander, it may be refueled by multiple launches of:
      New Glenn (expendable or reusable versions)
      ISRU via lunar tanker and another cislunar transporter coming from the Moon
   If the LEO station is used, it is previously refueled by multiple launches of:
      Falcon 9 tankers (expendable or reusable versions)
      Falcon Heavy tankers (expendable, partially reusable, or reusable versions)
      Starship tankers (expendable or reusable versions)
      New Glenn tankers (expendable or reusable versions)
      Vulcan tankers (version with 6 SRBs)
      Atlas V 551 tankers
      Terran R tankers (expendable or reusable versions)
      Ariane 6 tankers (version with 4 SRBs)
      ISRU via lunar tanker and cislunar transporter
   Note: Once again, the goal is to bring to LEO the minimum quantity of propellant for the Blue Moon lander to reach NRHO and perform descent and ascent. Falcon 9, Falcon Heavy, Starship, New Glenn, and Terran R have reusable first stages, reducing costs. Refueling may include more propellant if a second crew mission is scheduled.
   Phase 2: Blue Moon lander, after reaching LGW, is refueled by one of these options:
      Cislunar transporter refueled by LEO station
      Cislunar transporter refueled from KSC by New Glenn tankers
      ISRU via lunar tanker
   Phase 3: The crew of 4 is launched with SLS crew configuration+Orion to NRHO and docks with LGW+Blue Moon lander. Alternatives:
      SLS crew configuration Block 1
      SLS crew configuration Block 1B
      SLS crew configuration Block 2
   2 to 4 crew members descend to LSP using Blue Moon lander.
   Phase 4: The crew ascends to LGW and transfers to Orion which performs TEI for return trip. The Blue Moon lander remains docked with LGW for future crewed missions.
Total combinations for 1 mission: (3+15)×3×3×1=162 combinations
CONSECUTIVE CREWED MISSIONS:
Phases 1, 2, 3, and 4 in the first mission. For the second mission, the Blue Moon lander is already docked with LGW and refueled by one of the options used in phase 2 of the first mission. Phases 3 and 4 are then repeated as in the first mission.
Total combinations for 2 missions: 162×3×3=1,458 combinations

### Scenario 4: Lunar Cyclers Architecture

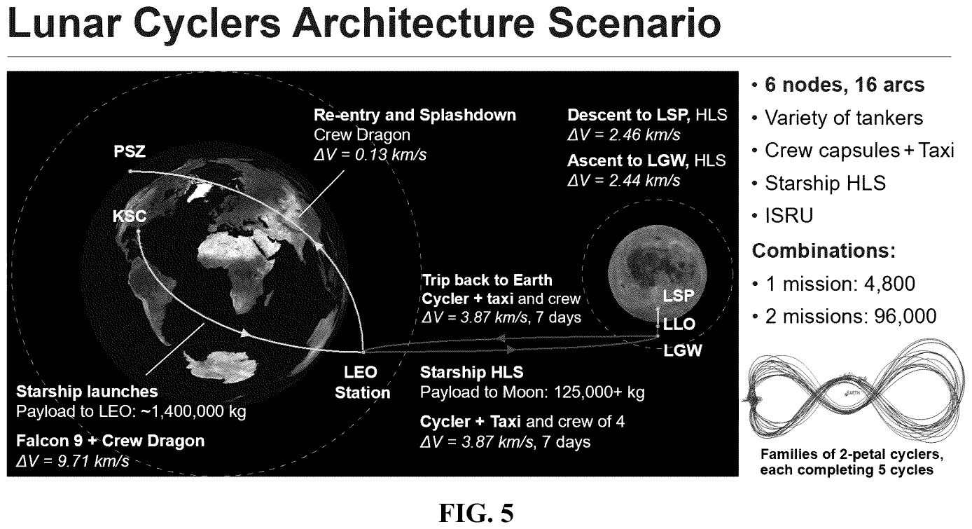

The last scenario, which is illustrated in FIG. 5, implements one or more lunar cyclers, i.e. spacecraft constantly orbiting the Earth-Moon system in a cyclical pattern, and involves the Lunar Gateway and a LEO station to create a reusable, sustainable Earth-Moon transport architecture. The crewed spacecraft is initially launched from KSC to the LEO station using a medium or light-lift rocket and a capsule, such as Falcon 9 with Crew Dragon or Vulcan with CST-100 Starliner. Once in LEO, the crew uses a taxi vehicle to rendezvous with the cycler trajectory for transit to the Lunar Gateway. The capsule remains docked to the LEO station, ready to be used later in the mission to carry the crew back to PSZ. Approaching NRHO, the taxi is detached from the cycler and utilized again to bring the crew to the Gateway, where the astronauts transfer to Starship HLS, previously launched and refueled in LEO as in scenario 2, to descend to LSP.

The crew retraces the same steps in reverse when finishing their lunar activities: they ascend from the Moon's surface to the Lunar Gateway via the lander, transfer to the taxi to rendezvous with the cycler trajectory and then with the LEO station during the return journey, and finally use the capsule to perform a controlled descent to PSZ.

This architecture, comprising a network of 6 nodes and a minimum of 11 arcs, demonstrates that cyclers could be a particularly interesting option for lunar exploration and beyond, as they are self-sustaining and offer a free ride to any mission that aligns with their orbital trajectory. Two different cycler configurations (2-petal and 5-petal versions) are analyzed in the optimization, whereas the capsule alternatives for the crew comprehend SpaceX's Crew Dragon, Boeing's CST Starliner, Sierra Space's Dream Chaser, and RKK Energia's Soyuz. A scenario involving lunar cyclers and the Blue Moon lander has also been conceptualized, but not included in the analysis presented in this document.

In summary, the fourth model implements one or more lunar cyclers, i.e. spacecraft constantly orbiting the Earth-Moon system in a cyclical pattern, the Lunar Gateway (LGW), and a LEO station to create a reusable, sustainable Earth-Moon transport system. The crewed spacecraft is initially launched from KSC to the LEO station using a medium or light-lift rocket and a capsule, such as Falcon 9 with Crew Dragon or Vulcan with CST-100 Starliner. Once there, the crew uses a taxi vehicle to rendezvous with the cycler for transit to LGW. The capsule remains docked to the LEO station, ready to be used later in the mission to carry the crew back to PSZ.

Approaching NRHO, the taxi is detached from the cycler and utilized again to bring the crew to LGW, where the astronauts transfer to Starship HLS (or the Blue Moon lander in model 4b) to descend to LSP. After completing lunar surface operations, the crew retraces the same steps in reverse: transferring from the lunar surface to LGW via the lander, using the taxi to rendezvous with the cycler trajectory and then with the LEO station during the return journey, and taking the capsule to perform a controlled descent to PSZ. Cyclers are particularly interesting as they are self-sustaining and offer a free ride to any mission that aligns with their orbital trajectory. The architectural goal of this model is to minimize the need for direct launches from Earth for every crewed mission to the Moon, using a reusable cycler as a transit hub to enhance mission efficiency.

MODEL 4a: Lunar Cyclers Architecture with Starship HLS
ASSUMPTIONS (valid for both scenarios 4a and 4b):
   Cislunar transporter, if used for refueling, is assumed to shuttle between LEO station and LGW.
   Taxi is assumed to have enough propellant for the entire mission after refueling in LEO.
   Minimum to zero leakage is assumed for any inert propellant in the LEO station or LGW to be used for the second mission.
   ISRU and lunar tanker shuttling between LSP and LGW are assumed fully deployed and operative, and the ISRU production is considered complete before the mission launches.
   All vehicles always carry the maximum cargo they are capable of transporting and/or the exact quantity of propellant to refuel LEO station for lunar missions.
NETWORK: 6 nodes, minimum 11 arcs.
TECHNOLOGY: launch vehicles (Starship, New Glenn, Falcon 9, Vulcan, Atlas V, Soyuz-2.1a), crew capsules (Dragon, CST-100 Starliner, Dream Chaser, Soyuz), taxi (Helios by Impulse Space), LEO station (by Axiom Space), tankers (Falcon 9, Falcon Heavy, Starship, New Glenn, Vulcan Centaur 6 SRBs, Atlas V 551, Terran R, Ariane 64, MLV by Firefly Aerospace and Northrop Grumman, Neutron, H3-24, cislunar transporter, lunar tanker), spacecraft (2-petal lunar cycler, 5-petal lunar cycler), Lunar Gateway, lunar landers (Starship HLS initial, Starship HLS sustaining, Blue Moon lander MK2), ISRU.
MISSION PHASES:
   Phase 1: LEO station is refueled by multiple launches of one of the following tanker options:
      Falcon 9 (expendable or reusable versions)
      Falcon Heavy (expendable, partially reusable, or reusable versions)
      Starship (expendable or reusable versions)
      New Glenn (only expendable version)
      Vulcan Centaur (6 SRBs version)
      Atlas V 551
      Terran R (expendable or reusable versions)
      Ariane 64
      MLV
      Neutron
      H3-24
   Note: The goal is to bring to LEO the minimum quantity of propellant for Starship HLS to reach LGW and perform descent and ascent. Falcon 9, Falcon Heavy, Starship, New Glenn, and Terran R have reusable first stages, reducing costs. Refueling may include more propellant if a second crew mission is scheduled.
   Phase 2: Starship HLS launched to LEO, refueled and sent to LGW. Alternatives:
      Starship HLS initial (2 astronauts to LSP)
      Starship HLS sustaining (4 astronauts to LSP)
   Phase 3: The taxi is launched to LEO station using one of the following compatible vehicles and refueled via LEO station:
      Falcon 9 (expendable or reusable versions)
      Falcon Heavy (expendable, partially reusable, or reusable versions)
      Starship (expendable or reusable versions)
      New Glenn (only expendable version)
      Vulcan Centaur
      Terran R (expendable or reusable versions)
      Ariane 6
      MLV
      Neutron
      H3-24
   Note: Taxi could also be launched when refueling LEO in Phase 1.
   Phase 4: The crew of 4 is launched from KSC to LEO with one of the following alternatives:
      Falcon 9+Dragon
      Vulcan+CST-100 Starliner
      Vulcan+Dream Chaser
      Atlas V+CST-100 Starliner
      Soyuz-2.1a+Soyuz
   Phase 5: The crew reaches LEO and takes the taxi to catch the lunar cycler's trajectory. Two options for cyclers:
      2-petal cycler
      5-petal cycler
   The cycler, with the taxi attached, carries the crew to NRHO. The taxi then brings the crew from the cycler trajectory to LGW. Once at Lunar Gateway, 2 to 4 crew members descend to LSP using Starship HLS
   Phase 6: Crew ascends to LGW with Starship HLS and transfers to the taxi to catch the cycler for return trip. HLS remains docked with LGW for future crewed missions. Approaching the Earth, the crew utilizes the taxi to go to LEO station, from where the astronauts take the same capsule previously used during launch to reenter and land at PSZ. Taxi remains in LEO for future missions.
Total combinations for 1 mission: 16×2×15×5×2=4,800 combinations
CONSECUTIVE CREWED MISSIONS:
Phases 1, 2, 3, 4, 5, and 6 in the first mission. For the second mission, taxi is in LEO station and refueled by one of the tankers in Phase 1. Starship HLS (initial or sustaining version) is already placed in NRHO at LGW and refueled by one of these options:
   LEO station via cislunar transporter
   ISRU with lunar tanker
Phases 4, 5, 6 are then repeated as in the first mission.
Total combinations for 2 missions: 4,800×2×5×2=96,000 combinations
   MODEL 4b: Lunar Cyclers Architecture with Blue Moon Lander
MISSION PHASES:
   Phase 1: LEO station is refueled by multiple launches of one of the following tanker options:
      Falcon 9 (expendable or reusable versions)
      Falcon Heavy (expendable, partially reusable, or reusable versions)
      Starship (expendable or reusable versions)
      New Glenn (expendable or reusable versions)
      Vulcan Centaur (6 SRBs version)
      Atlas V 551
      Terran R (expendable or reusable versions)
      Ariane 64
      MLV
      Neutron
      H3-24
      ISRU via lunar tanker and cislunar transporter
   Note: The goal is to bring to LEO the minimum quantity of propellant for the Blue Moon lander to reach LGW. Falcon 9, Falcon Heavy, Starship, New Glenn, Terran R have reusable first stages, reducing costs. Refueling may include more propellant if a second crew mission is scheduled.
   Phase 2: Blue Moon lander MK2 is launched to LEO by New Glenn, refueled and propelled to LGW.
   Phase 3: Blue Moon lander is refueled at LGW via cislunar transporter from LEO station or lunar tanker with propellant produced from ISRU.
   Phase 4: The taxi is launched to LEO station using one of the following compatible vehicles and refueled via LEO station:
      Falcon 9 (expendable or reusable versions)
      Falcon Heavy (expendable, partially reusable, or reusable versions)
      Starship (expendable or reusable versions)
      New Glenn (expendable or reusable versions)
      Vulcan Centaur
      Terran R (expendable or reusable versions)
      Ariane 6
      MLV
      Neutron
      H3-24
   Note: Taxi could also be launched when refueling LEO in Phase 1.
   Phase 5: The crew of 4 is launched from KSC to LEO with one of the following alternatives:
      Falcon 9+Dragon
      Vulcan+CST-100 Starliner
      Vulcan+Dream Chaser
      Atlas V+CST-100 Starliner
      Soyuz-2.1a+Soyuz
   Phase 6: The crew reaches LEO and takes the taxi to catch the lunar cycler's trajectory. Two options for cyclers:
      2-petal cycler
      5-petal cycler
   The cycler, with the taxi attached, carries the crew to NRHO. The taxi then brings the crew from the cycler trajectory to LGW. Once at Lunar Gateway, 2 to 4 crew members descend to LSP using the Blue Moon lander.
   Phase 7: Crew ascends to LGW with the Blue Moon lander and transfers to the taxi to catch the cycler for return trip. The Blue Moon lander remains docked with LGW for future crewed missions. Approaching the Earth, the crew utilizes the taxi to go to LEO station, from where the astronauts take the same capsule previously used during launch to reenter and land at PSZ. Taxi remains in LEO for future missions.
Total combinations for 1 mission: 18×2×16×5×2=5,760 combinations
CONSECUTIVE CREWED MISSIONS:
Phases 1, 2, 3, 4, 5, 6, and 7 in the first mission. For the second mission, taxi is in LEO station and refueled by one of the tankers in Phase 1. The Blue Moon lander is already placed in NRHO at LGW and refueled by one of these options:
   LEO station via cislunar transporter
   ISRU with lunar tanker
Phases 5, 6, and 7 are then repeated as in the first mission.
Total combinations for 2 missions: 5,760×2×5×2=115,200 combinations

### Results

This section describes the results of the optimization, providing insights into the optimal combinations of technologies applicable to each scenario and comparing the scenario performances against one another. Table 1 lists all the launch vehicle options considered for the analysis, indicating their payload mass to LEO (or to the Moon when specified), along with the cost per single launch in USD, adjusted for the 2024 inflation factor.

The costs are based on the most up-to-date values currently available on each company's homepage and may be subject to change in the near future, particularly those related to technologies still under development or testing. In the case of Saturn V, the original cost in 1969 USD was $185 million for the launch vehicle alone and $355 million including the Apollo spacecraft, which are then multiplied by the inflation factor 8.64 to convert them to today's equivalent values.

Table 1 also distinguishes between expendable and reusable configurations for a particular rocket, when applicable, and outlines each vehicle's calculated number of launches necessary to replenish the Starship depot, including boiloff contributions. This excludes Saturn V and the SLS Blocks, which are not considered for refueling. The calculations assume that the Starship HLS requires 1,200,000 kg of propellant to complete the mission, i.e. the maximum capacity it can store. The long-term cost per launch for a fully reusable version of Starship, which represents the second-best option in terms of payload mass to LEO and number of launches, is projected to decrease significantly over time, leading to substantial mission cost savings.

TABLE 1
Payload mass capabilities and cost for a variety of launch vehicles

| | Payload | Number | |
|---|---|---|---|
| Launch Vehicle/ | mass to LEO | of | Cost per launch (2024) |
| Manufacturing company | [kg] | launches | [USD] |
| Saturn V/NASA | 135,345.16 | 1 | 1.598 B launch vehicle |
| | (43,894.59 to | | 3.067 B including Apollo |
| | Moon) | | spacecraft |
| SLS Block 1, Crew/NASA | 27,000 | 1 | 2.500 B launch vehicle |
| | (to Moon) | | |
| SLS Block 1B, Crew/ | 38,000 | 1 | 4.719 B including Orion |
| NASA | (to Moon) | | and Ground Systems |
| SLS Block 2, Crew/NASA | 43,000 | 1 | |
| | (to Moon) | | |
| Falcon 9, expendable/ | 22,800 | 54 | 69.75M |
| SpaceX | | | 140.00M with Crew |
| | | | Dragon |
| Falcon 9, reusable/ | 16,800 | 74 | 50.00M |
| SpaceX | | | |
| Falcon Heavy, | 63,800 | 19 | 150.00M |
| expendable/SpaceX | | | |
| Falcon Heavy, | 57,000 | 22 | 97.00M |
| partially reusable/SpaceX | | | |
| Falcon Heavy, | 30,000 | 41 | 90.00M |
| fully reusable/SpaceX | | | |
| Starship, expendable/ | 250,000 | 5 | 100.00M |
| SpaceX | | | |
| Starship, reusable/ | 150,000 | 8 | 100.00M (significant |
| SpaceX | (100,000+ to | | cost reductions |
| | Moon) | | expected) |
| New Glenn/Blue Origin | 45,000 | 28 | 68.00M |
| | (7,000 to | | |
| | Moon) | | |
| Vulcan Centaur (6 SRBs)/ | 27,200 | 46 | 110.00M |
| ULA | | | |
| Atlas V 551/ULA | 18,850 | 66 | 153.00M |
| Terran R, expendable/ | 33,500 | 37 | Not available |
| Relativity Space | | | |
| Terran R, reusable/ | 23,500 | 54 | 55.00M |
| Relativity Space | | | |
| Ariane 64/Arianespace | 21,600 | 58 | 115.00M |
| MLV/Firefly Aerospace | 16,300 | 76 | Not available |
| and Northrop Grumman | | | |
| Neutron/Rocket Lab | 13,000 | 97 | 50.00M |
| H3-24/JAXA | 28,300 | 44 | 50.00M |

Table 2 shows the results obtained from the optimization, giving recommendations on the most efficient technology combinations for each scenario, accounting for the configurations that minimize initial mass to LEO, maximize the delivered mass, and optimize the delta-v budget at the minimum costs and number of launches. The Apollo 11 scenario is added to Table 2 as a reference and was not included in the optimization process.

TABLE 2
Comparison of technology combinations

| | Total | |
|---|---|---|
| Scenario | Combinations | Optimal combination of technologies |
| Apollo 11 | 1 | Saturn V with Apollo spacecraft (CSM + LM) |
| 1 mission | | |
| Apollo 11 | 1 | Saturn V with Apollo spacecraft (CSM + LM) |
| 2 missions | | |
| Artemis III | 42 | 5 Starship expendables to refuel the Starship HLS, SLS |
| 1 mission | | Block 2 with Orion, Starship HLS sustaining |
| Artemis III | 252 | 3 lunar tanker launches with ISRU-produced propellant to |
| 2 missions | | refuel the Starship HLS for the second mission |
| Artemis V | 3 | 8 New Glenn launches to bring the lander to the Moon and |
| 1 mission | | refuel it, SLS Block 2 with Orion, Blue Moon lander MK2 |
| Artemis V | 18 | 1 lunar tanker launch with ISRU-produced propellant to |
| 2 missions | | refuel the Blue Moon lander for the second mission |
| Cyclers | 4,800 | 5 Starship expendable to refuel the starship HLS, Falcon 9 |
| 1 mission | | with Crew Dragon, 2-petal cycler, Starship HLS sustaining |
| Cyclers | 96,000 | 3 lunar tanker launches with ISRU-produced propellant to |
| 2 missions | | refuel the Starship HLS for the second mission |

In the Artemis III architecture, the mission design involves selecting from seven SpaceX tanker options, two Starship HLS versions (initial and sustaining), and three SLS Block configurations. For Artemis V, the architecture simplifies to individual options for the tanker (New Glenn) and the lander (Blue Moon lander MK2), while the main variable becomes the choice among the SLS variants. The Cyclers scenario considers all the tanker options from Table 1 to refuel the Starship HLS and launch the taxi. This architecture also introduces two cycler configurations (2-petal and 5-petal) to the same combinations used in Artemis III. For the second mission of each scenario, the selection repeats the same combinations of the first mission adding the choice between using Earth-based refueling tankers or lunar tankers transporting propellant produced by ISRU.

From the results, in all architectures ISRU emerges as the most convenient option to refuel the lander in NRHO for future missions, requiring three Starship tanker launches carrying ISRU-derived propellant from the Moon surface for the second and fourth scenarios, and one lunar tanker launch for the third scenario.

In the Artemis V scenario, the eight New Glenn launches comprise two for deploying the lander and the cislunar transporter to LEO, one for refueling the lander in LEO before its transfer to NRHO, and five for delivering sufficient propellant to the Blue Moon lander to enable the descent and ascent. Calculations estimated that the Blue Moon lander requires 29,000 kg of propellant to achieve its fully fueled mass.

In the second and fourth scenarios, the Starship HLS sustaining version, transporting an assumed 120,000 kg of payload to the Moon compared to the 100,000 kg amount for the initial variant, is selected to maximize exploration capabilities. Furthermore, in scenario 4 the 2-petal cycler is preferred over the 5-petal variant due to its more frequent flyby opportunities for transferring the crew from LEO to NRHO, occurring every 7 days, if two cyclers are used, compared to 53 days for the 5-petal option. The 2-petal configuration also requires a lower delta-v requirement for NRHO transfers: 0.446 km/s against 0.528 km/s of the 5-petal version. The taxi is launched as part of the five Starship tankers' payload to eliminate the need for an additional launch.

Table 3 below shows the calculated delta-v values required for each trajectory within the four mission profiles, along with the corresponding vehicles that execute them.

TABLE 3
Delta-v requirements for mission scenarios and vehicles

| | Delta-v | Delta-v | Delta-v | Delta-v | Delta-v |
|---|---|---|---|---|---|
| | [km/s] | [km/s] | [km/s] | [km/s] | [km/s] |
| Scenario | KSC-LEO | LEO-LGW | LGW-LSP | LSP-LGW | LGW-PSZ |
| Apollo 11 | 9.584 | 4.133 | 2.144 | 1.891 | 1.001 |
| | (KSC-EPO) | (EPO-LLO) | (LLO-MT) | (MT-LLO) | (LLO-PSZ) |
| Artemis III | 10.100 | 3.953 | 2.460 | 2.440 | 1.000 |
| | SLS with | Orion | Starship | Starship | Orion |
| | Orion | | HLS | HLS | |
| Artemis V | 10.100 | 3.953 | 2.800 | 2.610 | 1.000 |
| | SLS with | Orion | Blue Moon | Blue Moon | Orion |
| | Orion | | lander | lander | |
| Cyclers | 9.705 | 3.865 | 2.460 | 2.440 | 3.993 |
| (2-petal | Falcon 9 | Taxi and | Starship | Starship | Taxi, cycler, |
| cycler) | | cycler | HLS | HLS | Crew |
| | | | | | Dragon |

Table 4 presents a comparison of the key performance parameters obtained from the four architectures, highlighting the minimum number of launches from Earth required to complete the mission, the initial mass carried to LEO, the payload mass delivered to Moon orbit, the total mission delta-v, and an estimation of the total mission cost based on the number of launches from Earth. The cost of lunar tanker launches is excluded from the result due to insufficient information regarding ISRU expenses, including plant deployment, propellant production, and the cost of launching from the Moon.

TABLE 4
Final results

| | | | | Total | |
|---|---|---|---|---|---|
| | Min. | Total mass | Total mass | mission | Total |
| | number of | to LEO | to Moon | delta-v | Cost |
| Scenario | launches | [kg] | [kg] | [km/s] | [USD] |
| Apollo 11 | 1 | 135,345.16 | 43,894.59 | 18.752 | 3.067 B |
| 1 mission | | | | | |
| Apollo 11 | 2 | 270,690.32 | 87,789.18 | 37.504 | 6.134 B |
| 2 missions | | | | | |
| Artemis III | 8 | Min: | Min: | 90.406 | 5.419 B |
| 1 mission | | 1,412,000 | 127,000 | | |
| | | Max: | Max: | | |
| | | 1,448,000 | 163,000 | | |
| Artemis III | 12 | Min: | Min: | 125.059 | 10.138 B |
| 2 missions | | 1,439,000 | 154,000 | | |
| | | Max: | Max: | | |
| | | 1,491,000 | 206,000 | | |
| Artemis V | 9 | Min: | Min: | 100.416 | 5.263 B |
| 1 mission | | 152,000 | 72,000 | | |
| | | Max: | Max: | | |
| | | 168,000 | 88,000 | | |
| Artemis V | 11 | Min: | Min: | 125.779 | 9.982 B |
| 2 missions | | 179,000 | 99,000 | | |
| | | Max: | Max: | | |
| | | 211,000 | 131,000 | | |
| Cyclers | 8 | Min: | Min: | 92.916 | 840M |
| 1 mission | | 1,397,500 | 106,500 | | |
| | | Max: | Max: | | |
| | | 1,424,500 | 126,500 | | |
| Cyclers | 12 | Min: | Min: | 130.079 | 980M |
| 2 missions | | 1,403,500 | 113,000 | | |
| | | Max: | Max: | | |
| | | 1,437,500 | 133,000 | | |

With an expendable configuration, the total mass delivered to the Moon for Apollo 11 is smaller than the payloads of the other architectures, as the mission was designed only for minimal surface operations. In contrast, Artemis missions demonstrate higher logistical requirements to support extended lunar operations but maintain a comparable cost range. The high expenses reflect the increased complexity of modern mission designs and the use of multiple vehicles and several launches. Cyclers offer a promising alternative with significantly lower costs due to the absence of the expensive Orion spacecraft, and a similar delta-v budget to the Artemis missions.

According to certain non-limiting examples, the systems and methods disclosed herein provide mathematical, modeling, and optimization techniques applied to space logistics that enhance the rigor and efficiency of space mission design and decision-making processes. The systems and methods disclosed herein involve the development of an end-to-end logistics supply chain optimization model for sustainable and resilient space exploration, designed to optimize key performance parameters under varying scenarios throughout the entire lifecycle of space missions. The systems and methods disclosed herein improve the current state-of-the-art inefficient Earth-based supply mission planning by providing sustainable, adaptable architectures for different interplanetary scenarios, ensuring resilience, cost-effectiveness, and scalability in future exploration missions.

The systems and methods disclosed herein addresses the emerging lunar space economy by informing decisions regarding architectures that support human cislunar development and sustainability. The main objective is to determine the optimal architecture for Artemis Missions and human spaceflight endeavors, in support of NASA, the commercial space sector, and the U.S. Space Force, with the ultimate goal of guiding the development of future Earth-Moon-Mars supply chain systems. Key aspects include the utilization of SpaceNet, an MIT-NASA modeling and simulation environment for space exploration logistics, to develop various lunar scenarios' visual representations comprising network (nodes and trajectories), assets, and operations within the architecture, and the integration of separate modeling for optimization.

The systems and methods disclosed herein provide the development and application of the model's optimization algorithm to maximize the efficiency of NASA's Artemis Missions architectures and lunar exploration initiatives beyond Artemis V. The algorithm includes:
orbital mechanics calculations and rocket equation implementation to compute orbital and mission parameters (e.g., mass history at each location, delta-v for each maneuver, etc.).
integer linear programming (ILP) as the optimization technique to determine the most effective combinations of technologies over time at each phase of the mission or campaign, adjusting the selection and resource flows based on mission constraints and goals.
Monte Carlo simulations to assess the impact of the uncertainties in the model's variables, such as propellant and payload mass estimations.

The formulation incorporates contributions to the logistics of many existing technologies and emerging innovative systems under development, such as In-Situ Resource Utilization (ISRU), the Lunar Gateway, and the Blue Moon lander, alongside conceptual and potential future space infrastructure, including lunar cyclers and post-ISS LEO stations and support assets. These technologies are modeled based on their current capabilities or expected Technology Readiness Level (TRF), with adjustable parameters for conceptual systems to account for varying assumptions.

The model is designed to integrate any current or future technology, taking as inputs:
initial masses (dry mass, propellant mass, payload mass) of rockets, spacecraft, landers, or other space vehicles.
propulsion system parameters, including specific impulse (Isp), thrust (T), or delta-v if known.
cost per single launch and cost-per-unit of resources or consumables flowing into the network.
additional inputs such as the quantity and types of commodities, including estimates for uncertain parameters via lower and upper bounds, evaluated through Monte Carlo simulations.
   If exact values are not available, estimations derived from orbital mechanics or pre-defined parameter ranges are used.

Outputs of the algorithm comprise the total mass (inflow and outflow) in each node of the given architecture, total delta-v, and mission cost, as well as the best combination of technologies to maximize resource efficiency:
Total mass at a certain node of the network is calculated by summing all the mass components delivered by launch vehicles, spacecraft, or landers at a location, including dry mass, residual propellant mass, cargo mass, as well as transfer stages, in-orbit propellant tanks, space taxis, and other auxiliary systems mass. The calculation also accounts for reusable and expendable systems.
Total delta-v is derived from the sum of the delta-v for each maneuver, computed based on trajectory type, payload mass carried, rocket design, and environmental factors (celestial body's gravity, atmospheric drag, and planetary alignment).
Total cost is determined from the cost per single launch, the total mass sent to LEO, the number and type of commodities, the cost-per-unit of each commodity, the systems reusability, the network design, and the mission duration.

The model achieves various optimization objectives, including:
Minimize initial mass to LEO to reduce launch costs and maximize payload delivery to final destination (Lunar South Pole—LSP) to enhance exploration capabilities and scientific return, and increase redundancy, mission duration, and mission success rate.
Reduce total delta-v (fuel consumption).
Minimize mission costs and mission risk.
Improve the resilience of the baseline architecture and assets, enabling robust mission planning.
Determine the best combination of technologies that achieves these goals—individually and collectively—for both a single mission and two consecutive crewed missions of each architecture, comparing the performance of the various technology combinations, and evaluating results against the best configurations for other scenarios and state-of-the-art expendable launches.

According to certain non-limiting examples, the algorithm's general mathematical formulation to determine the optimal flow of k commodities across a network of N nodes and A arcs, ensuring supply meets demand:

$$Minimize ( or maximize ) the objective function \cdot ℱ = \sum {w}_{ij} {x}_{ij}$$

where
wᵢⱼ=weight (e.g., cost-per-unit) of commodity/resource
xᵢⱼ=quantity of commodity/resource flowing into the network
i=initial node
j=arrival node
   Example of minimizing initial mass and maximizing final mass:

$$weighted objective function ℱ == \sum {w}_{1 ij} {M}_{1 ij} - \sum {w}_{2 ij} {M}_{2 ij}$$

where
M₁ᵢⱼ=total initial mass in low Earth orbit (LEO), including dry mass, propellant mass, and cargo mass of
launch vehicles. Cargo mass includes payloads, such as scientific instrumentation for lunar missions, ECLSS, and crew.
M₂ᵢⱼ=total final mass at final destination (Lunar South Pole, LSP), including dry mass, propellant mass, and cargo mass of landers. Cargo mass includes payloads, ECLSS, and crew.
w₁ᵢⱼ=weight for minimizing launch vehicles mass
w₂ᵢⱼ=weight for maximizing lunar landers mass
   Setting w₁ᵢⱼ=0 implies determining the most efficient combination of technologies that only maximizes final mass, whereas w2ij=0 indicates identifying the combination that only minimizes initial mass in LEO.

Constraints are also incorporated into the algorithm, including system compatibility, operational feasibility, lower and upper bounds for the variables, mass balance at each node, inflow-outflow relationship, capacity constraints, and non-negativity.

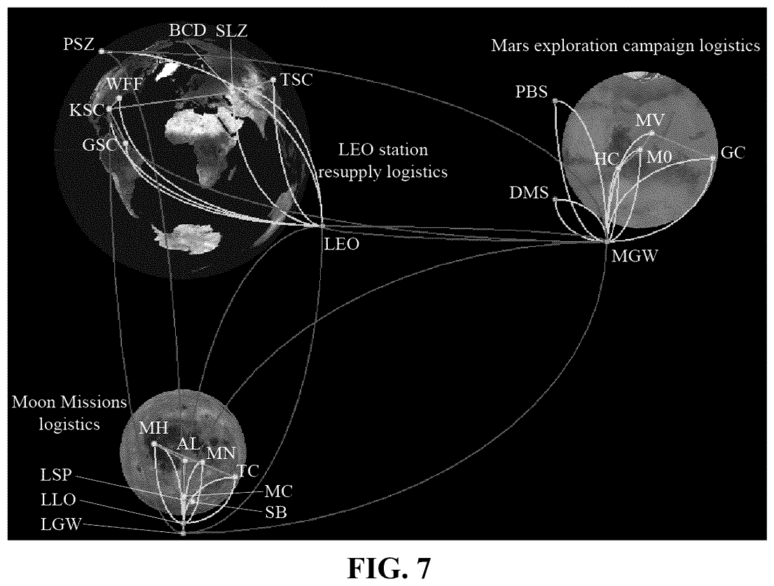

FIG. 7 illustrates an Earth-Moon-Mars supply chain architecture. The model includes the ISS/a future commercial station in LEO orbit, a Lunar Gateway (LGW), and a Mars Gateway (MGW), connected to key scientific sites such as the Lunar South Pole (LSP) on the Moon and Gale Crater (GC) on Mars.

The Earth-Moon-Mars supply chain architecture is for a preliminary Earth-Moon-Mars model including a LEO station, the Lunar Gateway (LGW), and a potential future Mars Gateway (MGW), each connected between each other by different route types, and allowing access to various key scientific destinations on the Moon and Mars starting from diverse launching sites on the Earth. The model is applicable for both crewed and uncrewed missions to the Moon and Mars, and may involve any current or future technology (e.g., lunar or Mars cyclers, ISRU, etc.).

In contrast to prior space logistics approaches that focus on direct supply missions, with limited infrastructure for extensive interplanetary missions, the systems and methods disclosed herein are applicable to deep space exploration missions that include fully integrated campaigns spanning multiple celestial bodies. The systems and methods disclosed herein provide adaptable end-to-end supply chain models to accommodate the diverse requirements of both Moon and Mars missions.

The systems and methods disclosed herein improve the state of the art by developing cutting-edge space logistics architecture models. The models can support and leverage NASA's planned yearly deep space launches and private interplanetary objectives, as well as to help coordinate human spaceflight endeavors and guide the progress of upcoming Artemis Missions and commercial space efforts. Optimization analysis can be used to enhance network reliability and supply chain resilience, including Multifidelity and Monte Carlo simulations for risk assessment and sensitivity analysis on key performance parameters.

The systems and methods disclosed herein can be used to generate a comprehensive and precise Earth-Moon-Mars supply chain model which can produce performance metrics for various supply chain scenarios. The model can include key feasibility studies for the incorporation of advanced ISRU, the Lunar Gateway, Lunar Cyclers, and a potential Mars Gateway, to facilitate sustainable lunar and interplanetary missions.

### Sensitivity Analysis

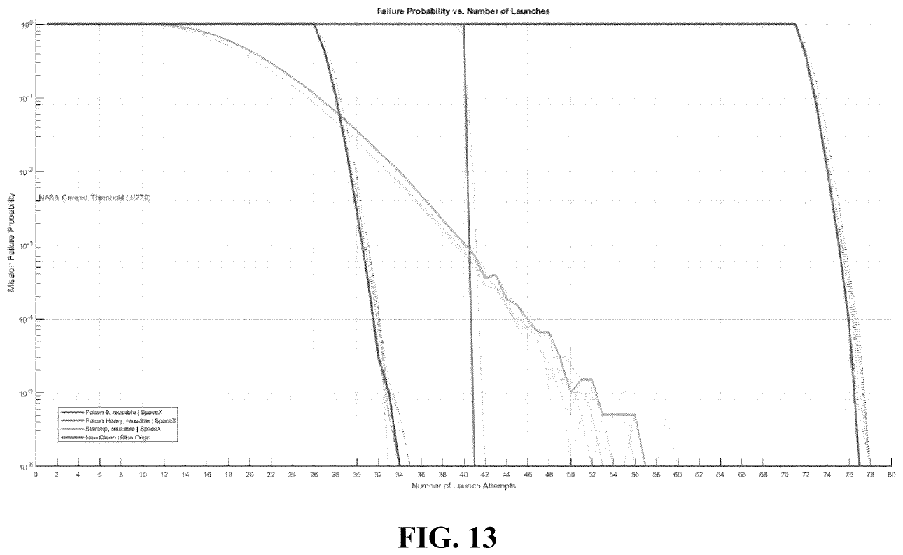

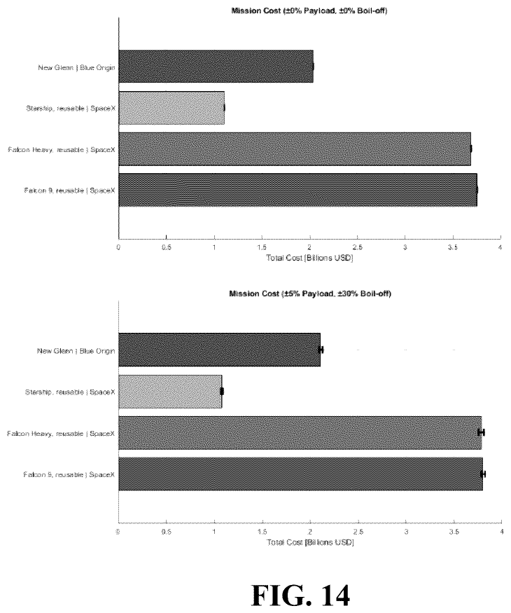

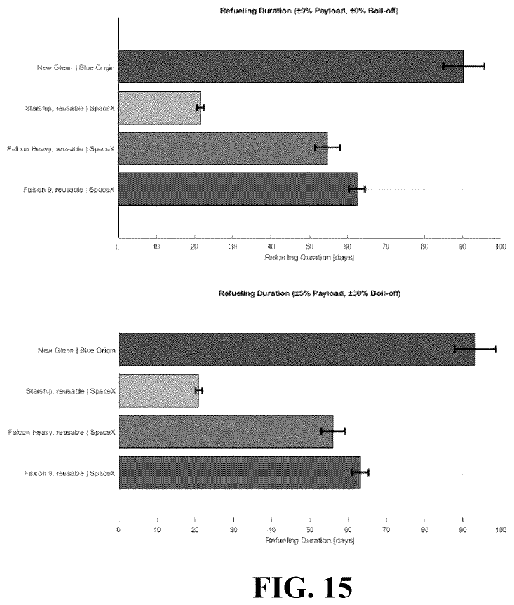

Referring to FIGS. 13-15, and related to the above disclosure, a sensitivity analysis was conducted to investigate payload (mass), weather delays, and boiloff, considering uncertainties on payload, boiloff, and weather delays. In general, the analysis:
determines the minimum reliable number of launches for most representative launch vehicles to replenish the Starship depot (target mass=1.2·10⁶ kg) with launch failure probability <1/270 (<0.37%, i.e. success rate >99.63%).
involves Monte Carlo Simulations (MCS), integrating Bernoulli distribution for launch success/failure and Normal distribution to model payload (±2%, ±5%) and boiloff (±25%, ±30%) uncertainties. Sample Size=2·10⁵ runs, Max Attempts=80.

The Sensitivity Analysis utilized the following inputs:

### Inputs (Based on Historical Data):

| | | | Nominal | | Weather | |
|---|---|---|---|---|---|---|
| | Nominal | | delta_t | Launch | Delay | Weather |
| Launch | Payload | Cost per kg | (Turnover | Success | (Mean Value) | Standard |
| Vehicle | [kg] | [USD/kg] | time) | Rate | [days] | Deviation |
| Falcon 9 | 16,800 | 2976 | 0.33 | 99.39% | 0.5 | 0.25 |
| reusable | | | | | | |
| Falcon | 30,000 | 3000 | 0.33 | 100% | 1 | 0.5 |
| Heavy | | | | | | |
| reusable | | | | | | |
| Starship | 150,000 | 200 | 0.33 | 44% | 0.25 | 0.15 |
| reusable | | (assumed) | | | | |
| New Glenn | 45,000 | 1511 | 1 | 98% | 2 | 1 |

Results included the following:

### Results Summary (Worst Case Scenario):

| | Min. Launches | Refueling | Total | |
|---|---|---|---|---|
| | with failure < | Duration | Refueling Cost | Failure |
| Launch Vehicle | 1/270 | [days] | [Billions USD] | Rate |
| Falcon 9 | 76 | 63.24 ± 2.14 | 3.80 ± 0.02 | 0.22% |
| reusable | | | | |
| Falcon Heavy | 42 | 56.04 ± 3.18 | 3.78 ± 0.03 | <0.01% |
| reusable | | | | |
| Starship | 37 | 21.57 ± 0.87 | 1.11 ± 0.01 | 0.35% |
| reusable | | | | |
| New Glenn | 31 | 93.27 ± 5.45 | 2.11 ± 0.02 | 0.28% |

Some observations of the subject analysis include the following:
Starship is best for low-cost and fast refueling; however, it just meets the risk threshold.
Falcon Heavy is the most reliable, but expensive.
Falcon 9 is too launch-intensive to be viable for large-scale refueling.
New Glenn is launch-efficient, requiring the fewest launches, but suffers from long turnover duration, limiting its utility for time-critical missions.

In general, the subject sensitivity analysis reveals that the number of launches and launch cost are primarily impacted by payload uncertainty, whereas changes in boil-off uncertainty do not substantially affect the results.

### Supply Chain Logistics Optimization

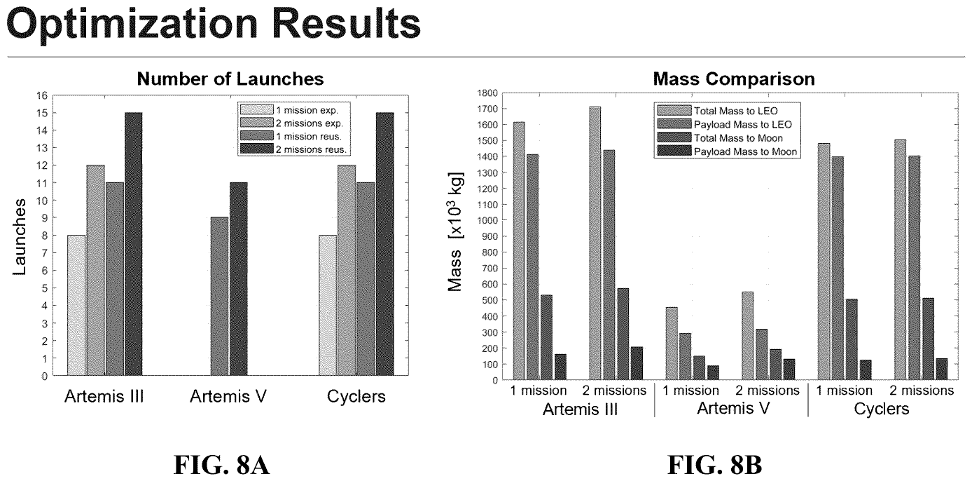

Referring to FIGS. 8-11, and related to the above disclosure, aspects of the above inventive concepts can be implemented for supply chain logistics assets optimization to, e.g., optimize a space exploration supply chain by identifying critical assets for Artemis and other missions in deep space exploration scenarios.

Technical Problems: Various technical challenges must be addressed when addressing or planning for the complexity of deep space exploration. Present limitations include inefficient, expendable, point-to-point transportation and high costs from Earth-based supply dependence which are not sustainable for, e.g., interplanetary missions.

Technical Solutions: To address the technical challenges associated with the complexity of deep space exploration, the disclosure includes a first-order model configured to provide an analysis of potential asset combinations and optimization of predefined mission key performance parameters. In some examples, the model is a supply chain optimization model to intelligently plan in-space refueling (LEO station, depots, ISRU, etc.) and configuration of reusable assets (boosters, taxis, cyclers, etc.).

As previously discussed, FIG. 1 illustrates example assumptions, and FIG. 2 provides an example of an optimization model that can include an optimization algorithm that uses integer linear programming for optimization of predefined mission key performance parameters in various exploration scenarios and/or architectures.

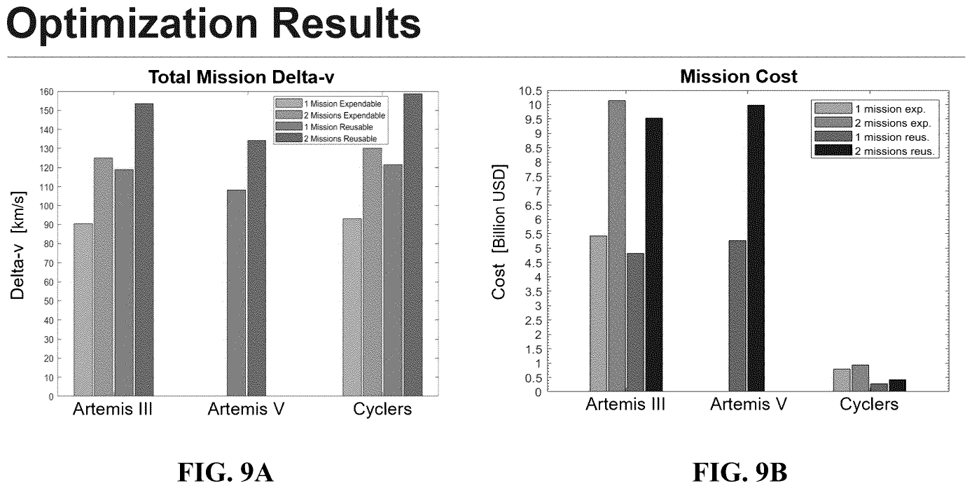

FIGS. 3-5 illustrate three example architecture scenarios that can be optimized using the optimization model described herein. FIGS. 8A-8B and FIGS. 9A-9B show the optimization results of the three architecture scenarios of FIGS. 3-5. Regarding FIG. 8A, the following was observed:
5 exp./8 reus. Starship tankers to refuel HLS
4 New Glenn tankers to refuel Cislunar Taxi

Regarding FIG. 8B, the following was observed:
Artemis III exp.: highest payload to Moon (206K kg tot.)
Artemis V reus.: fewest launches, reduced LEO mass

Regarding FIG. 9A-9B, the following was observed:
Reusable missions reduce total costs, but require ~20% higher ΔV and 3 extra launches compared to exp.
Cost savings: $600M (~10%) for Artemis III, $500M (~60%) for Cyclers—overall ~7× cheaper than Artemis

### Reliability Analyses

In some aspects, the optimization model can be modified or configured to be more realistic by adding uncertainties and failure probabilities based on TRL and historical data for each phase of the mission.

Results for refueling phase (shown below): minimum reliable number of launches for most representative launch vehicles to replenish the Starship depot (1.2·10⁶ kg) with launch failure probability <1/270 (<0.37%).

| | | | | Min. | |
|---|---|---|---|---|---|
| | | | Min. | Launches | Cost |
| | Nominal | Launch | Launches | with | per kg |
| Launch | Payload | Success | (boiloff | failure | [USD/ |
| Vehicle | [kg] | Rate | only) | rate | kg] |
| Falcon 9 reus. | 16,800 | 99.39% | 74 | 75 | 2976 |
| Falcon Heavy | 30,000 | 100% | 41 | 41 | 3000 |
| reus. | | | | | |
| Starship exp. | 250,000 | 44% | 5 | 25 | 400 |
| Starship reus. | 150,000 | 44% | 8 | 36 | 200* |
| New Glenn | 45,000 | 98%* | 28 | 31 | 1511 |

*Assumed Values

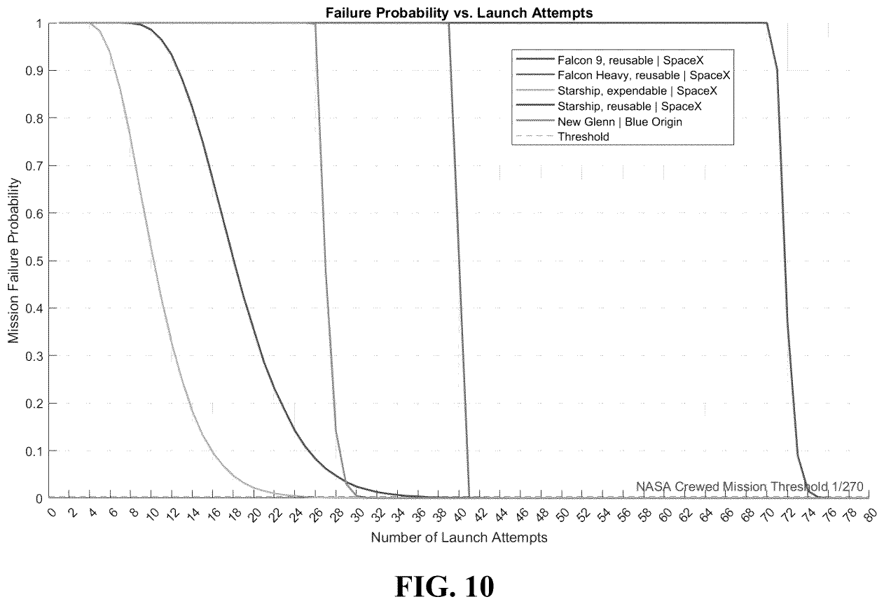

FIG. 10 illustrates refueling phase initial results, and Monte Carlo Simulations:
Bernoulli distribution for launch success/failure
Normal distribution for payload (±5%) and boiloff (±25%) uncertainties
Success Rate: >99.63%
Sample Size: 10⁶ runs
Target Mass: 1.2·10⁶ kg
Max Attempts: 80

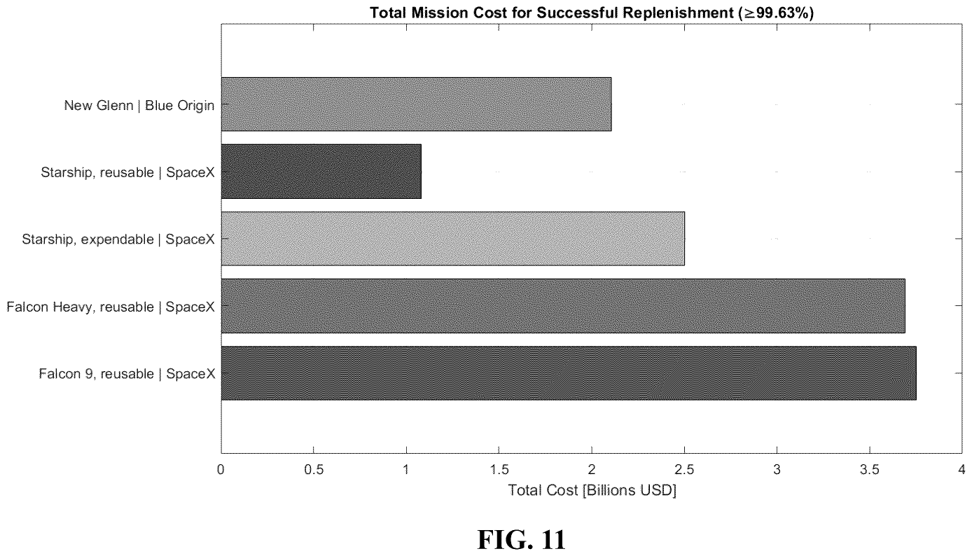

FIG. 11 compares total mission cost, in billions of U.S. dollars, for a plurality of launch-vehicle options, wherein each cost corresponds to achieving a replenishment success probability at or above a predefined threshold.

As previously shown, FIG. 5 illustrates the preliminary Earth-Moon-Mars supply chain architecture. The above scenarios and analyses highlight the ability via the optimization concepts herein to optimize additional lunar scenarios, and extend model capabilities to Earth-Moon-Mars architecture. Further, datasets used herein can be refined or supplemented, ISRU modeling can be improved, reliability analyses can be finalized for each mission phase to determine the minimum number of assets for a reliable and resilient supply chain, and market-driven analysis can be conducted to identify the optimal type of assets for enhancing low-performance Earth launch systems.

The foregoing illustrates that sustainable architecture with lunar refueling as a key feature that can enable a strategic advantage. Additional sophisticated optimization modeling with uncertainties can determine necessary capabilities and their optimal deployment order. Adding more robust supply chain assets can increase the viability of lower-performance Earth launch assets, resulting in a more robust supply chain. In some examples, the optimization model can identify which and how many assets the optimized market requires.

### FURTHER EXAMPLES

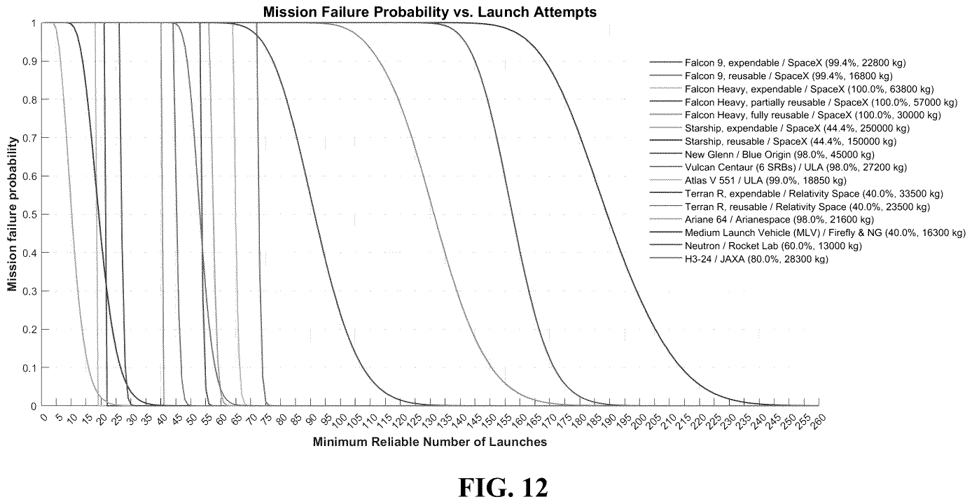

FIG. 12 illustrates further information associated with the present disclosure.

### Additional Findings:

In terms of booster reusability, reusable missions are more cost-effective and sustainable than expendable missions, reducing total costs by 600M USD (~10%) for Artemis III and 500M USD (~60%) for the Cyclers architecture, despite requiring ~20% higher delta-v and 3 additional launches to deliver the same mass to LEO and to the Moon.
For Artemis III and Lunar Cyclers scenarios, fully refueling Starship HLS with propellant, including boil-off losses, was determined to require a minimum of 5 expendable or 8 reusable Starship tankers. For Artemis V, refueling the Cislunar Transporter with the propellant needed for the Blue Moon lander in NRHO and the trip back to LEO requires a minimum of 4 New Glenn tankers. In all scenarios, the refueling process is assumed to be completed in less than a week (~5 days) to minimize boil-off losses.
In the expendable configuration, Artemis III delivers the highest payload to the Moon (163K kg in 1 mission, 206K kg in total across both missions)~nearly 2× higher than Artemis V and 1.3× higher than Cyclers in 1 mission, 1.5× higher than both in 2 missions—using the lowest delta-v budget (~3-17% lower than other scenarios), but at the highest cost, though comparable to Artemis V.
Among the reusable configurations, Artemis V requires the fewest launches (2 fewer per mission) and has the lowest delta-v budget (~9-15% lower), despite delivering a lower payload to the Moon, but significantly reducing the mass transported to LEO.
Cyclers Architecture represents a markedly lower-cost alternative, ~7× cheaper than the Artemis missions as it does not involve the expensive SLS, with the reusable configuration further reducing overall costs by ~60%. It assumes a minimum of two 2-petal cyclers orbiting the Earth-Moon system every 7 days, a taxi that connects the cycler trajectory to the LGW or to LEO, and a LEO station and LGW fully deployed and operational. A disadvantage of this strategy is that a single cycler has a limited payload capacity (corresponding to the taxi capacity)—in our case-study, 6,500 kg per LEO-to-Moon transfer—requiring the support of additional assets to enhance mission efficiency.

TABLE 5
Key Performance Parameters (KPPs) of the 1-mission case study for the three optimized scenarios,
Expendable v. Reusable

| | | | Minimum | Maximum | Total | |
|---|---|---|---|---|---|---|
| | | Minimum | mass to | mass to the | mission | |
| Optimized Scenario | | total | LEO | Moon | delta-v | Total Cost |
| 1 mission | | launches | [x10³ kg] | [x10³ kg] | [km/s] | [USD] |
| Artemis | Expendable | 8 | total: 1,615 | total: 530 | 90.406 | 5.419 B |
| III | Reusable | 11 | payload: 1,412 | payload: 163 | 118.906 | 4.819 B |
| | Exp./Reus. | 0.73 | Same Mass | Same Mass | 0.76 | 1.12 |
| | | | to LEO | to Moon | | |
| Artemis | Reusable | 9 | total: 455 | total: 149 | 108.322 | 5.263 B |
| V | | | payload: 292 | payload: 88 | | |
| Lunar | Expendable | 8 | total: 1,481.3 | total: 506 | 92.916 | 795 M |
| Cyclers | Reusable | 11 | payload: 1,397.5 | payload: 126.5 | 121.416 | 285 M |
| | Exp./Reus. | 0.73 | Same Mass | Same Mass | 0.77 | 2.79 |
| | | | to LEO | to Moon | | |

TABLE 6
KPPs of the 2-mission case study involving ISRU refueling for the 3 optimized scenarios,
Exp. vs. Reus.

| | | | Minimum | Maximum | Total | |
|---|---|---|---|---|---|---|
| | | Minimum | mass to | mass to the | mission | |
| Optimized Scenario | | total | LEO | Moon | delta-v | Total Cost |
| 2 missions/ISRU | | launches | [x10³ kg] | [x10³ kg] | [km/s] | [USD] |
| Artemis | Expendable | 12 | total: 1,710 | total: 573 | 125.059 | 10.138 B |
| III | Reusable | 15 | payload: 1,439 | payload: 206 | 153.559 | 9.538 B |
| | Exp./Reus. | 0.8 | Same Mass | Same Mass | 0.81 | 1.06 |
| | | | to LEO | to Moon | | |
| Artemis | Reusable | 11 | total: 550 | total: 192 | 134.195 | 9.982 B |
| V | | | payload: 319 | payload: 131 | | |
| Lunar | Expendable | 12 | total: 1,504.1 | total: 512.5 | 130.079 | 935 M |
| Cyclers | Reusable | 15 | payload: 1,403.5 | payload: 133 | 158.579 | 425 M |
| | Exp./Reus. | 0.8 | Same Mass | Same Mass | 0.82 | 2.2 |
| | | | to LEO | to Moon | | |

### Computing System

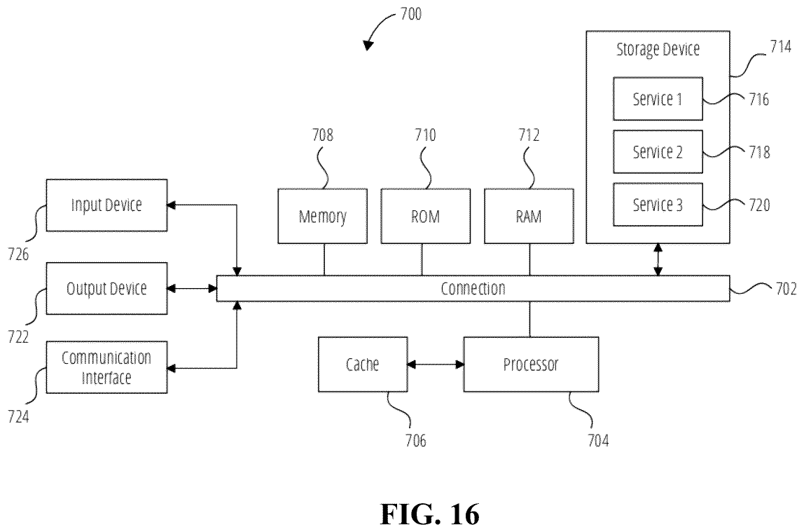

FIG. 16 shows an example of computing system 700, which can be any computing device for executing the systems and methods disclosed herein and/or making up components of the system which are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU) (e.g., processor 704) and connection 702 that couples various system components including system memory 708, such as read-only memory (e.g., ROM 710) and random access memory (e.g., RAM 712) to processor 704. Computing system 700 can include a cache of high-speed memory 706 connected directly with, in close proximity to, or integrated as part of processor 704.

Processor 704 can include any general-purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Clauses

The present technology includes computer-readable storage mediums for storing instructions, and systems for executing any one of the methods embodied in the instructions addressed in the clauses of the present technology presented below:
Clause 1. A method of planning and optimizing logistics for space travel, the method comprising: selecting a plurality of space vehicles to realize a predefined space mission including travel to a destination location from an originating location selecting a plurality of space maneuvers to perform the predefined space mission, wherein the plurality of space maneuvers includes a launch maneuver from an originating celestial body to a first intermediate position; determining a destination mass that is delivered to the destination location from the first intermediate position using the plurality of space vehicles performing the plurality of space maneuvers, wherein, at first intermediate position, the plurality of space vehicles have a first mass; and selecting a combination of space vehicles and space maneuvers for the plurality of space vehicles and the plurality of space maneuvers, respectively, that simultaneously minimizes the first mass and maximizes the destination mass.
Clause 2. A method of planning and optimizing logistics for space travel, the method comprising: selecting a first set of space vehicles to perform a predefined space mission including traveling to a destination location from an originating location; selecting a first set of space maneuvers performed by the first set of space vehicles that realizes the predefined space mission, wherein the first set of space maneuvers includes a launch maneuver from an originating celestial body to a first intermediate position; determining a first destination mass associated with a first initial mass, wherein the destination mass is a mass that is delivered to the destination location by the first set of space vehicles performing the first set of space maneuvers, and the initial mass is an aggregated mass of the first set of space vehicles at the first intermediate position: repeating determinations of destination masses corresponding to initial masses for a plurality of combinations of sets of space vehicles with respective sets of space maneuvers, wherein the sets of space vehicles performing the respective sets of space maneuvers realize the predefined space mission, wherein the destination masses corresponding to the initial masses include the first destination mass corresponding to the first initial mass; and selecting a combination of a selected set of space vehicles performing a selected set of space maneuvers for which the destination mass is maximized while the corresponding initial mass is minimized.
Clause 3. The method of clause 1 or clause 2, wherein: the originating position is on earth, the first intermediate position is a low earth orbit (LEO), a Near-Rectilinear Halo Orbit (NRHO) around a Moon, or an Earth-lunar Lagrange point, or an Earth parking orbit.
Clause 4. The method of any of clauses 1-4, wherein the first mass of the plurality of space vehicles at the first intermediate position is a total mass including a space-vehicle mass, a propellant mass, a passenger mass, and a cargo mass.
Clause 5. The method of any of clauses 1-4, further comprising: determining an aggregated cost for a first combination of the plurality of combinations of the sets of space vehicles with the respective sets of space maneuvers, wherein the aggregated cost of the first combination includes a total cost of the first set of space vehicles, a cost of maintenance of the first set of space vehicles, and a total cost for performing the first set of space maneuvers.
Clause 6. The method of clause 5, further comprising: determining an aggregated delta-v for performing the first set of space maneuvers using the first set of space vehicles.
Clause 7. The method of any of clauses 1-6, further comprising: calculating an objective function as a weighted combination of the destination mass and the corresponding initial mass, and selecting the combination of the selected set of space vehicles performing the selected set of space maneuvers based on optimizing the objective function.
Clause 8. The method of clause 2, further comprising: using integer linear programming to determine an optimal combination of a set of space vehicles and space maneuvers that optimizes the objective function subject to one or more constraints.
Clause 9. The method of clause 8, further comprising: applying statistical analysis to using the integer linear programming to determine the optimal combination.
Clause 10. The method of clause 9, wherein applying the statistical analysis includes performing a Monte Carlo simulation.
Clause 11. The method of clause 8, wherein the one or more constraints includes: a first constraint ensuring system compatibility among the sets of space vehicles, a second constraint ensuring operational feasibility, a third constraint providing lower and upper bounds for inputs to the integer linear programming, a fourth constraint ensuring mass balance at each node, a fifth constraint providing inflow-outflow relationship, a sixth constraint providing rocket capacity constraints, and/or a seventh constraint ensuring non-negativity applied to a flow.
Clause 12. The method of clause 8, wherein the one or more constraints includes a lower bound for a delta-v of the sets of space maneuvers to reach the destination location such that the one or more constraints ensure that the delta-v exceeds a combination of a required delta-v a predefined margin.
Clause 13. The method of any of clauses 1-12, wherein the first set of maneuvers includes an Earth-based launch to Earth parking orbit, one or more refueling maneuvers at an Earth parking orbit, a Trans-Lunar Injection trajectory (TLI), a descent to low-lunar orbit.
Clause 14. The method of any of clauses 1-13, wherein the first set of space vehicles includes one or more lunar cyclers, one or more reusable orbit transfer vehicles, a lander vehicle, and/or a tanker vehicle.
Clause 15. The method of any of clauses 1-14, wherein the first set of space vehicles includes one or more public-sourced space vehicles and one or more private-sourced space vehicles.
Clause 16. A non-transitory computer-readable storage medium, the computer-readable storage medium including instructions that when executed by a computer, cause the computer to: perform steps of one or more of the methods of clauses 1-15.
Clause 16. A computing apparatus comprising: a processor; and a memory storing instructions that, when executed by the processor, configure the apparatus to: perform steps of one or more of the methods of clauses 1-15.

The foregoing description has been directed to specific embodiments. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method of planning and optimizing logistics for space travel, the method comprising:
selecting a first set of space vehicles to perform a predefined space mission including traveling to a destination location from an originating location;
selecting a first set of space maneuvers performed by the first set of space vehicles that realizes the predefined space mission, wherein the first set of space maneuvers includes a launch maneuver from an originating celestial body to a first intermediate position;
determining a first destination mass associated with a first initial mass, wherein the destination mass is a mass that is delivered to the destination location by the first set of space vehicles performing the first set of space maneuvers, and the initial mass is an aggregated mass of the first set of space vehicles at the first intermediate position:
repeating determinations of destination masses corresponding to initial masses for a plurality of combinations of sets of space vehicles with respective sets of space maneuvers, wherein the sets of space vehicles performing the respective sets of space maneuvers realize the predefined space mission, wherein the destination masses corresponding to the initial masses include the first destination mass corresponding to the first initial mass; and
selecting a combination of a selected set of space vehicles performing a selected set of space maneuvers for which the destination mass is maximized while the corresponding initial mass is minimized.

2. The method of claim 1, wherein:
the originating position is on Earth, and
the first intermediate position is a low earth orbit (LEO), a Near-Rectilinear Halo Orbit (NRHO) around a Moon, or an Earth-lunar Lagrange point, or an Earth parking orbit.

3. The method of claim 1, wherein a mass of the selected set of space vehicles at the first intermediate position is a total mass including a space-vehicle mass, a propellant mass, a passenger mass, and a cargo mass.

4. The method of claim 1, further comprising:
determining an aggregated cost for a first combination of the plurality of combinations of the sets of space vehicles with the respective sets of space maneuvers,
wherein the aggregated cost of the first combination includes a total cost of the first set of space vehicles, a cost of maintenance of the first set of space vehicles, and a total cost for performing the first set of space maneuvers.

5. The method of claim 1, further comprising:
calculating an objective function as a weighted combination of the destination mass and the corresponding initial mass; and
selecting the combination of the selected set of space vehicles performing the selected set of space maneuvers based on optimizing the objective function.

6. The method of claim 5, further comprising:
using integer linear programming to determine an optimal combination of a set of space vehicles and space maneuvers that optimizes the objective function subject to one or more constraints.

7. The method of claim 6, wherein applying statistical analysis includes performing a Monte Carlo simulation.

8. The method of claim 6, wherein the one or more constraints includes:
a first constraint ensuring system compatibility among the sets of space vehicles,
a second constraint ensuring operational feasibility,
a third constraint providing lower and upper bounds for inputs to the integer linear programming,
a fourth constraint ensuring mass balance at each node,
a fifth constraint providing inflow-outflow relationship,
a sixth constraint providing rocket capacity constraints, and/or
a seventh constraint ensuring non-negativity applied to a flow.

9. The method of claim 6, wherein the one or more constraints includes a lower bound for a delta-v of the sets of space maneuvers to reach the destination location such that the one or more constraints ensure that the delta-v exceeds a combination of a required delta-v a predefined margin.

10. The method of claim 1, wherein the first set of maneuvers includes an Earth-based launch to Earth parking orbit, one or more refueling maneuvers at an Earth parking orbit, a Trans-Lunar Injection trajectory (TLI), and a descent to low-lunar orbit.

11. The method of claim 1, wherein the first set of space vehicles includes one or more lunar cyclers, one or more reusable orbit transfer vehicles, a lander vehicle, and/or a tanker vehicle.

12. The method of claim 1, wherein the first set of space vehicles includes one or more public-sourced space vehicles and one or more private-sourced space vehicles.

13. A non-transitory computer-readable storage medium, the computer-readable storage medium including instructions that when executed by a computer, cause the computer to:
select a first set of space vehicles to perform a predefined space mission including traveling to a destination location from an originating location;
select a first set of space maneuvers performed by the first set of space vehicles that realizes the predefined space mission, wherein the first set of space maneuvers includes a launch maneuver from an originating celestial body to a first intermediate position;
determine a first destination mass associated with a first initial mass, wherein the first destination mass is a mass that is delivered to the destination location by the first set of space vehicles performing the first set of space maneuvers, and the first initial mass is an aggregated mass of the first set of space vehicles at the first intermediate position;
repeat determinations of destination masses corresponding to initial masses for a plurality of combinations of sets of space vehicles with respective sets of space maneuvers, wherein the sets of space vehicles performing the respective sets of space maneuvers realize the predefined space mission, wherein the destination masses corresponding to the initial masses include the first destination mass corresponding to the first initial mass; and
select a combination of a selected set of space vehicles performing a selected set of space maneuvers for which the destination mass is maximized while the corresponding initial mass is minimized.

14. The non-transitory computer-readable storage medium of claim 13, wherein the instructions further cause the computer to:
use integer linear programming to determine an optimal combination of a set of space vehicles and space maneuvers that optimizes an objective function subject to one or more constraints.

15. The non-transitory computer-readable storage medium of claim 14, wherein the one or more constraints includes:
a first constraint ensuring system compatibility among the sets of space vehicles,
a second constraint ensuring operational feasibility,
a third constraint providing lower and upper bounds for inputs to the integer linear programming,
a fourth constraint ensuring mass balance at each node,
a fifth constraint providing inflow-outflow relationship,
a sixth constraint providing rocket capacity constraints, and/or
a seventh constraint ensuring non-negativity applied to a flow.

16. The non-transitory computer-readable storage medium of claim 13, wherein the first set of space vehicles includes one or more lunar cyclers, one or more reusable orbit transfer vehicles, a lander vehicle, and/or a tanker vehicle.

17. A computing apparatus comprising:
a processor; and
a memory storing instructions that, when executed by the processor, configure the apparatus to:
select a first set of space vehicles to perform a predefined space mission including traveling to a destination location from an originating location;
select a first set of space maneuvers performed by the first set of space vehicles that realizes the predefined space mission, wherein the first set of space maneuvers includes a launch maneuver from an originating celestial body to a first intermediate position;
determine a first destination mass associated with a first initial mass, wherein the first destination mass is a mass that is delivered to the destination location by the first set of space vehicles performing the first set of space maneuvers, and the first initial mass is an aggregated mass of the first set of space vehicles at the first intermediate position;
repeat determinations of destination masses corresponding to initial masses for a plurality of combinations of sets of space vehicles with respective sets of space maneuvers, wherein the sets of space vehicles performing the respective sets of space maneuvers realize the predefined space mission, wherein the destination masses corresponding to the initial masses include the first destination mass corresponding to the first initial mass; and
select a combination of a selected set of space vehicles performing a selected set of space maneuvers for which the destination mass is maximized while the corresponding initial mass is minimized.

18. The computing apparatus of claim 17, wherein the instructions further configure the computing apparatus to:
use integer linear programming to determine an optimal combination of a set of space vehicles and space maneuvers that optimizes an objective function subject to one or more constraints.

19. The computing apparatus of claim 18, wherein the one or more constraints includes:
a first constraint ensuring system compatibility among the sets of space vehicles,
a second constraint ensuring operational feasibility,
a third constraint providing lower and upper bounds for inputs to the integer linear programming,
a fourth constraint ensuring mass balance at each node,
a fifth constraint providing inflow-outflow relationship,
a sixth constraint providing rocket capacity constraints, and/or
a seventh constraint ensuring non-negativity applied to a flow.

20. The computing apparatus of claim 17, wherein the first set of space vehicles includes one or more lunar cyclers, one or more reusable orbit transfer vehicles, a lander vehicle, and/or a tanker vehicle.
